(19) United States
(12) Patent Application Publication
(10) Pub. No.: US 2013/0215144 A1
(43) Pub. Date: Aug. 22, 2013

(54) DISPLAY CONTROL DEVICE AND DISPLAY CONTROL METHOD

(71) Applicant: SONY CORPORATION, (US)

(72) Inventors: Hiroyuki ANZAI, Chiba (JP); Shunsuke AOKI, Tokyo (JP)

(73) Assignee: SONY CORPORATION, Tokyo (JP)

(21) Appl. No.: 13/714,592

(22) Filed: Dec. 14, 2012

(30) Foreign Application Priority Data
Feb. 20, 2012 (JP) 2012033871
Feb. 20, 2012 (JP) 2012033872

(51) Int. Cl. G09G 5/22

(52) U.S. Cl. CPC G09G 5/22
USPC 345/619

(57) ABSTRACT

There is provided a display control device including a display control unit that causes a reproduction image of content that includes a first section and a second section and a reproduction state display that indicates a reproduction state of the content to be displayed on a display unit, wherein the reproduction state display includes a first bar that indicates the first section, a second bar that is displayed in a continuation of the first bar and indicates the second section, or a first icon that is displayed on the first bar instead of the second bar so as to indicate that the second section is not reproduced.

### BACKGROUND

The present disclosure relates to a display control device and a display control method.

A technique of displaying a reproduction state display such as a progress bar together with a reproduction image in order to easily ascertain which part of content the scene being reproduced is when a user views the content has been known. For example, Japanese Unexamined Patent Application Publication No. 2008-67207 discloses a technique of displaying a portion recorded in content on such a progress bar.

### SUMMARY

In recent years, however, the kind of content that users view has been diversified, and it is not rare for content that is obtained by extracting a portion (or by cutting out another portion) of original content to be viewed. In such cases, displaying a progress bar as disclosed in, for example, Japanese Unexamined Patent Application Publication No. 2008-67207 is not sufficient for meeting users' needs.

Thus, the present disclosure proposes a novel and improved display control device and display control method that enable users to comfortably view content including a cut portion.

According to an embodiment of the present disclosure, there is provided a display control device including a display control unit that causes a reproduction image of content that includes a first section and a second section and a reproduction state display that indicates a reproduction state of the content to be displayed on a display unit. The reproduction state display includes a first bar that indicates the first section, a second bar that is displayed in a continuation of the first bar and indicates the second section, or a first icon that is displayed on the first bar instead of the second bar so as to indicate that the second section is not reproduced.

Further, according to an embodiment of the present disclosure, there is provided a display control method including displaying a reproduction image of content including a first section and a second section and a reproduction state display that indicates a reproduction state of the content on a display unit. The reproduction state display includes a first bar that indicates the first section, a second bar that is displayed in a continuation of the first bar and indicates the second section, or a first icon that is displayed on the first bar instead of the second bar so as to indicate that the second section is not reproduced.

According to the above configurations, since the cut second section is displayed as the first icon, display of the first bar is concise. In addition, by causing the second section to be displayed as the second bar, the second section can also be reproduced. In other words, it is possible to reproduce cut portions using an instantaneous operation.

According to the present disclosure as described above, it is possible to allow a user to view content including cut portions more comfortably.

### BRIEF DESCRIPTION OF THE DRAWINGS

FIG. 1 is a schematic block diagram showing a functional configuration of a system according to an embodiment of the present disclosure;

FIG. 2 is a diagram for describing an operation of a system according to an embodiment of the present disclosure;

FIG. 3A is a diagram showing an example of shared setting according to an embodiment of the present disclosure;

FIG. 3B is a diagram showing an example of shared setting according to an embodiment of the present disclosure;

FIG. 3C is a diagram showing an example of shared setting according to an embodiment of the present disclosure;

FIG. 3D is a diagram showing an example of shared setting according to an embodiment of the present disclosure;

FIG. 4 is a diagram for describing event information according to an embodiment of the present disclosure;

FIG. 5A is a diagram for describing scenario information according to an embodiment of the present disclosure;

FIG. 5B is a diagram for describing scenario information according to an embodiment of the present disclosure;

FIG. 6 is a diagram for describing reproduction of content using scenario information according to an embodiment of the present disclosure;

FIG. 7 is a diagram for describing generation of scenario information and a thumbnail image according to an embodiment of the present disclosure;

FIG. 8 is a diagram for describing selection of target content according to an embodiment of the present disclosure;

FIG. 9A is a diagram for describing generation of a thumbnail image and a thumbnail scenario according to an embodiment of the present disclosure;

FIG. 9B is a diagram for describing generation of a thumbnail image and a thumbnail scenario according to an embodiment of the present disclosure;

FIG. 9C is a diagram for describing generation of a thumbnail image and a thumbnail scenario according to an embodiment of the present disclosure;

FIG. 9D is a diagram for describing generation of a thumbnail image and a thumbnail scenario according to an embodiment of the present disclosure;

FIG. 10A is a diagram for describing generation of a highlight scenario according to an embodiment of the present disclosure;

FIG. 10B is a diagram for describing generation of a highlight scenario according to an embodiment of the present disclosure;

FIG. 10C is a diagram for describing generation of a highlight scenario according to an embodiment of the present disclosure;

FIG. 11 is a diagram for describing a whole display during content view according to an embodiment of the present disclosure;

FIG. 12 is a diagram showing an example of a normal mode reproduction screen according to an embodiment of the present disclosure;

FIG. 13A is a diagram showing an example of a highlight mode reproduction screen according to an embodiment of the present disclosure;

FIG. 13B is a diagram showing an example of a highlight mode reproduction screen according to an embodiment of the present disclosure;

FIG. 13C is a diagram showing an example of a highlight mode reproduction screen according to an embodiment of the present disclosure;

FIG. 13D is a diagram showing an example of a highlight mode reproduction screen according to an embodiment of the present disclosure;

FIG. 14 is a diagram for describing an operation of a system according to another embodiment of the present disclosure; and

FIG. 15 is a block diagram for describing a hardware configuration of an information processing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Introduction

2. Whole Configuration

3. Operation of Content Providing User

4. Process in Shared Server
4-1. Overview
4-2. Details

5. Display During Content View

6. Supplement

### (1. Introduction)

Before providing description of an embodiment of the present disclosure, relevant matters thereof will be first described.

An embodiment of the present disclosure relates to a system in which a user uploads content including images (still images) or moving images photographed by the user to a server so that the user himself or herself views the content or shares it with other users.

The content generated herein is an image or a moving image photographed using a digital camera, or the like, in an event, for example, an athletic meeting, travel, or the like. Such content is stored as an image file or a moving image file with a file name based on, for example the date on which it was photographed. A user who does not have a high level of IT literacy or who is indolent stores or shares content in the original format without change. Even other users will usually merely change the file name so as to include the title of the event or put a tag of the title of the event in a unit of file.

When such content as described above is shared with other users, it is not necessarily easy for the users to view the shared content. When content using a file name directly based on the date on which it was photographed is shared, for example, other users do not know in what event the file was photographed (this is the same when the user himself or herself who photographed the content views it after some time has elapsed). In addition, even if the file name or the like makes it possible to know in what event the content was photographed, details thereof are not able to be known.

It is assumed that, for example, there is content photographed by parents in an athletic meeting of their child. In the content, there are portions which show their child, portions which show their child's friends, and portions which merely show the result of the race. When the content is to be shared with grandparents, the grandparents only want to see content that shows their grandchild (the child). However, it is difficult to distinguish content that shows the grandchild from content that does not based on, for example file names. In addition, even if content that shows their grandchild is known by tags inserted into files, for example, an awkward task of viewing scenes in which the grandchild does not appear using fast forwarding is necessary in a case of, for example, moving image content.

In such a case, the parents who provide the content may also consider selecting content to share with the grandparents, but in order to do this, they should review the content to understand it first, which requires enormous time and effort. In addition, when the content is moving images, for example, there are cases in which portions that show the grandchild and portions that do not are mixed in one file, so it is not realistic for many users to prepare content for sharing even by editing moving images. Further, interesting portions in content differ depending on users who view the content (for example, such portions are the grandchild (the child) for the grandparents, the child and his or her friends for his or her friends, and the friends and the result of the race for the child himself or herself).

Thus, considering the circumstances, according to an embodiment of the present disclosure, while efforts of a user who provides content by automatically extracting the content appropriate for sharing from content generated by the user are reduced, a comfortable viewing experience for users who view the content is realized.

### (2. Whole Configuration)

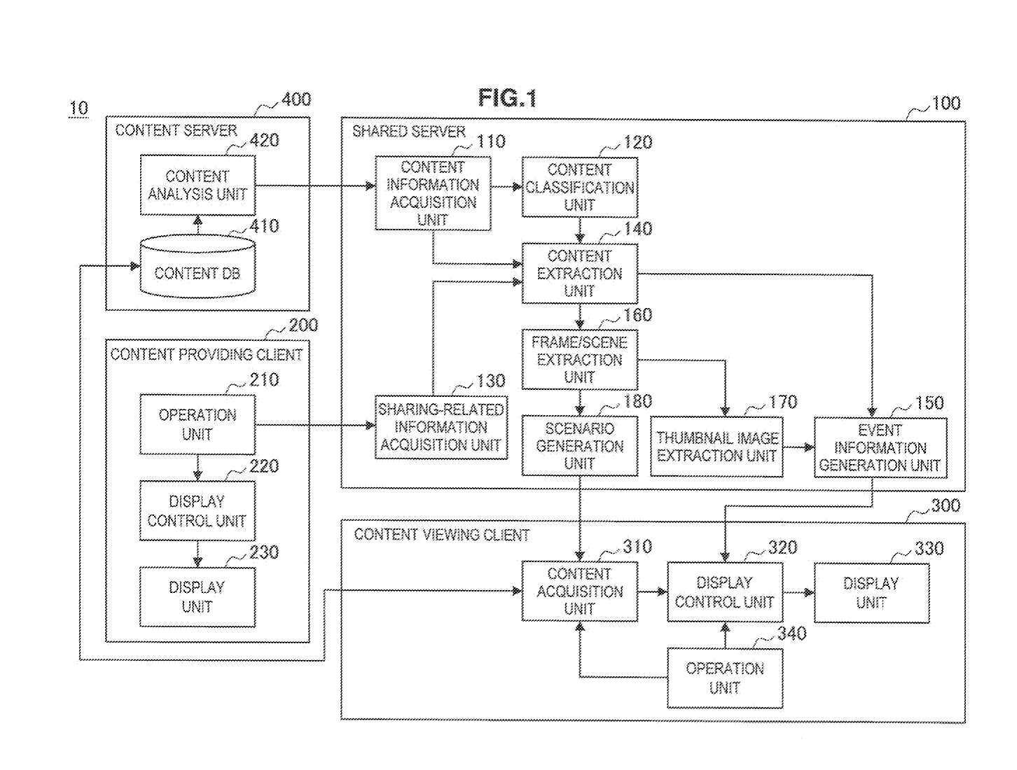

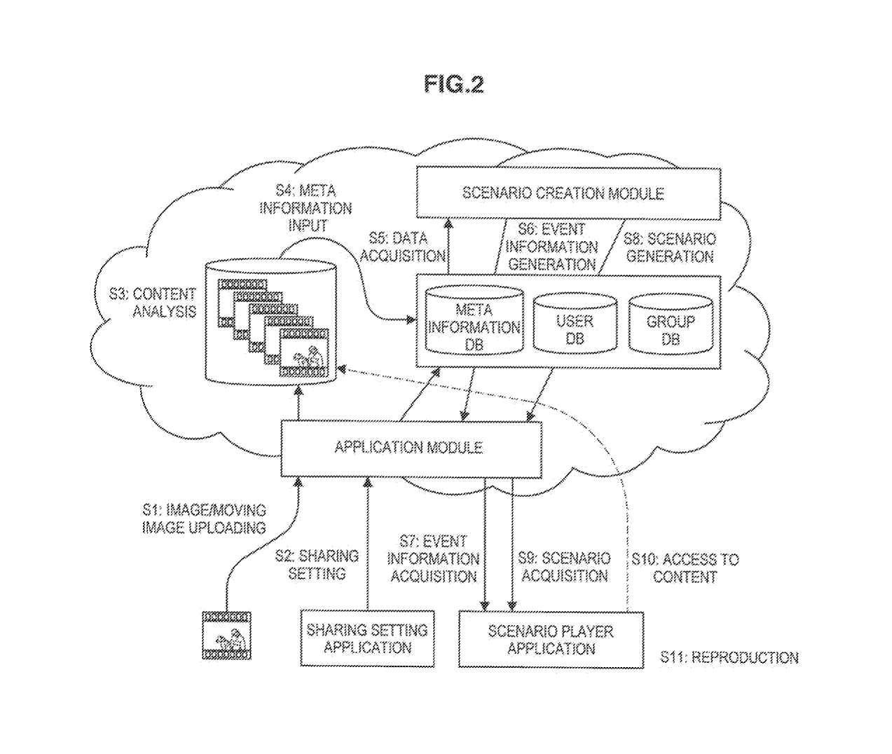

Hereinbelow, the whole configuration of an embodiment of the present disclosure will be described with reference to FIGS. 1 and 2. FIG. 1 is a schematic block diagram showing a functional configuration of a system according to an embodiment of the present disclosure. FIG. 2 is a diagram for describing an operation of a system according to an embodiment of the present disclosure.

### (2-1. Functional Configuration of System)

Referring to FIG. 1, a system 10 according to an embodiment of the present disclosure includes a shared server 100, a content providing client 200, a content viewing client 300, and a content server 400.

### (Shared Server)

The shared server 100 is a server installed on a network, and realized as, for example, an information processing device to be described later. The shared server 100 includes, as functional configuration elements, a content information acquisition unit 110, a content classification unit 120, a sharing-related information acquisition unit 130, a content extraction unit 140, an event information generation unit 150 a frame/scene extraction unit 160, a thumbnail image extraction unit 170, and a scenario information generation unit 180. Each of the functional configuration elements is realized, for example, by operating a CPU (Central Processing Unit), a RAM (Random Access Memory), and a ROM (Read Only Memory) in accordance with a program stored in a storage device or a removable recording medium.

Note that the shared server 100 may not necessarily be realized as a single device. For example, the function of the shared server 100 may be realized by having resources of a plurality of devices cooperate through a network.

The content information acquisition unit 110 acquires information of content from a content analysis unit 420 of the content server 400. The content analysis unit 420 analyzes content uploaded by a user who provides the content, and acquires information of, for example, an event for which the content is photographed, information of a person appearing in images or moving images that are the content, or the like as, for example, meta-information of the content.

The content classification unit 120 classifies content based on information acquired by the content information acquisition unit 110. In this embodiment, classifying content includes classifying the content for each event to be photographed. Classification of content for each event is executed using a result obtained in such a way that the content analysis unit 420 of the content server 400 clusters the content based on distribution of photographed dates as will be described below.

The sharing-related information acquisition unit 130 acquires a target user that is a sharing partner of content and information of a target subject that is a subject associated with each target user from the content providing client 200. The target subject is one that is assumed to be a target of interest when the target user views the content. In the example described above, the target user is the grandparents and the target subject is the grandchild (child). Note that the target user and the target subject will be described later in detail.

Further, the sharing-related information acquisition unit 130 may acquire information of an event which is permitted to be disclosed for each target user. Accordingly, even without finely setting content of which sharing is permitted for every target user, it is possible to set whether or not content is to be shared with a corresponding user in units of events. Such setting can be used in cases of sharing setting in which content photographed during travel with grandparents is shared only with the grandparents, and content photographed during an athletic meeting is shared not only with the grandparents but also with friends of the child, even if the same child appears in both cases of the content.

The content extraction unit 140 extracts content in which a target subject appears from content provided by a user (content of which information is acquired by the content information acquisition unit 110) based on information acquired by the sharing-related information acquisition unit 130. The content extracted herein is also called target content hereinbelow. When a target user is designated, for example, the content extraction unit 140 extracts content in which a target subject in association with the target user appears as target content. Thus, when there are a plurality of target users, for example, target content extracted by the content extraction unit 140 can differ depending on designated target users.

Further, the content extraction unit 140 can extract target content for each event based on classification of content by the content classification unit 120. Accordingly, for example, it is possible to generate scenarios for each event during generation of scenarios to be described later. In addition, in the event information generation unit 150, it is possible to generate information presenting content in units of events. When the sharing-related information acquisition unit 130 acquires information for designating an event that is permitted to be disclosed for each target user, the content extraction unit 140 may extract target content for an event corresponding to, for example, a designated target user.

The event information generation unit 150 generates event information based on a result obtained in such a way that the content extraction unit 140 extracts target content for each event and then outputs the information to the content viewing client 300. The event information is information for presenting an event including content in which a target subject in association with a target user appears to the target user who views the content (in other words, an event from which a scenario can be generated by the scenario information generation unit 180 to be described later). As described above, an event from which target content is extracted may be limited by information acquired by the sharing-related information acquisition unit 130.

The frame/scene extraction unit 160 extracts a frame or a scene that meets a predetermined condition from a moving image included in target content. Herein, a frame means each of images that constitute a moving image in a continuous manner. In addition, a scene means a series of frames that constitute a portion or the whole of target content. For example, the frame/scene extraction unit 160 extracts a portion in which a target subject appears from a moving image included in target content as a target scene. Further, the frame/scene extraction unit 160 may select a representative scene from target scenes for each moving image.

In addition, the frame/scene extraction unit 160 may extract frames in which a target subject appears from moving images included in target content as target frames and select a representative frame for each of the moving images from the target frames. Note that an image (still image) included in target content can be provided to the scenario information generation unit 180 and the thumbnail image extraction unit 170 as it is without undergoing a process in the frame/scene extraction unit 160. Details of the corresponding process of the frame/scene extraction unit 160 will be described later.

The thumbnail image extraction unit 170 extracts thumbnail images that summarize content of an event in a short form for target content extracted by the content extraction unit 140 for each event using an extraction result of frames by the frame/scene extraction unit 160. Such a thumbnail image may be, for example, one image or frame (hereinafter, also referred to as an event representative image) or an animation made by combining a plurality of images or frames (hereinafter, also referred to as a flip thumbnail). Note that, as a thumbnail, a moving image constituted by representative scenes of images and moving images (hereinafter, also referred to as a thumbnail moving image) can also be generated, but the image is generated by the function of the scenario information generation unit 180 to be described later.

Herein, when the thumbnail image extraction unit 170 extracts an event representative image, the thumbnail image extraction unit 170 can also be called a representative image selection unit that selects an event representative image from representative frames extracted by the frame/scene extraction unit 160 and images (still images) included in target content. Note that, when content only includes moving images, for example, an event representative image is selected from representative frames.

On the other hand, when the thumbnail image extraction unit 170 generates flip thumbnails, the thumbnail image extraction unit 170 can also be called an animation generation unit that generates a digest animation (flip thumbnails) by combining representative frames extracted by the frame/scene extraction unit 160 and images (still images) included in target content. Note that, when content only includes moving images, for example, flip thumbnails are generated by combining representative frames.

Thumbnail images extracted by the thumbnail image extraction unit 170 are provided to the event information generation unit 150 in the form of, for example, image data, and output to the content viewing client 300 together with event information. In the content viewing client 300, thumbnail content is presented together with the event information for target users who view content so as to make it easy to understand, for example, details of the content classified for each event.

The scenario information generation unit 180 generates a scenario for reproducing digest content by combining content for target content extracted by the content extraction unit 140 and outputs the scenario to the content viewing client 300 as scenario information. The scenario information is used when the content acquisition unit 310 of the content viewing client 300 accesses the content server 400 to acquire content and then reproduces the content as digest content as will be described later. The scenario information generation unit 180 may use an extraction result of frames or scenes obtained by the frame/scene extraction unit 160 in generating the scenario information.

In addition, the scenario information generation unit 180 can generate a scenario for content set to be shared either before or after acquisition of information by the sharing-related information acquisition unit 130. In other words, when sharing is set, the scenario information generation unit 180 generates a scenario for content set to be shared before the setting, and also generates a scenario for content additionally set to be shared after the setting.

Herein, digest content includes, for example, both of highlight moving images and thumbnail moving images. A highlight moving image is a moving image reproduced in combination of target scenes extracted by the frame/scene extraction unit 160 from moving images included in target content and images (still images) included in the target content. Note that, when target content only includes moving images, for example, a highlight moving image is a moving image reproduced with successive target frame portions of each of the moving images. A scenario for reproducing such highlight images is also called a highlight scenario hereinbelow. A highlight moving image reproduced using a highlight scenario in the content viewing client 300 is offered for, for example, target users for viewing.

On the other hand, a thumbnail moving image is a moving image obtained by combining a representative scene selected from target scenes that the frame/scene extraction unit 160 extracts from moving images included in target content and an image (still image) included in the target content. Note that, when the target content only includes moving images, for example, a highlight moving image is an image reproduced with successive representative frame portions of each moving image. A scenario for constituting such a thumbnail moving image is also called a thumbnail scenario hereinbelow. A thumbnail moving image reproduced using a thumbnail scenario in the content viewing client 300 is displayed with event information when, for example, a target user selects content to be viewed while viewing the event information.

Note that, as described above, the content classification unit 120 classifies content for each event, and the content extraction unit 140 extracts target content for each event in this embodiment. Thus, the scenario information generation unit 180 also generates a scenario for each event.

### (Content Providing Client)

The content providing client 200 is a client connected to the shared server 100 via a network, and is realized as, for example, an information processing device to be described later. The content providing client 200 includes, as functional configuration elements, an operation unit 210, a display control unit 220, and a display unit 230. More specifically, the content providing client 200 can be, for example, a PC of a desktop, a notebook, or a tablet type that a user has, a television receiver set, a recorder, a smartphone, or a mobile media player with a network communicating function, or the like, but it is not limited thereto, and can be any of various devices that are capable of having the above-described functional configuration.

The operation unit 210 is realized by various input devices that are provided in the content providing client 200 or connected as externally-connected devices, and acquires operations of a user for the content providing client 200. The operation unit 210 includes, for example, a pointing device such as a touch pad or a mouse, and may provide users with operations with a GUI (Graphical User Interface) in cooperation with the display control unit 220 and the display unit 230 to be described later.

Herein, an operation of a user that the operation unit 210 acquires includes an operation for setting a target user who is a target for sharing content and a target subject in association with each target user. Note that a user who operates the content providing client 200 is a user who provides content, and in many cases, a user who photographs the content. In the example described above, the operation unit 210 acquires an operation by the parents to designate the grandparents as target users and to associate the grandchild (child) as a target subject with the grandparents who are target users. An example of such an operation will be described below with an example of a GUI component.

The display control unit 220 is realized by operating, for example, a CPU, a RAM, and a ROM in accordance with a program stored in a storage device or a removable recording medium, and controls display of the display unit 230. As described above, the display control unit 220 may cause the display unit 230 to display the GUI component that is operated via the operation unit 210. Note that an example of the GUI component will be described later.

The display unit 230 is realized as a display device such as an LCD (Liquid Crystal Display) or an organic EL (Electro-luminescence) display that, for example, the content providing client 200 has as an output device or that is connected to the content providing client 200 as an externally-connected device. The display unit 230 displays various images in accordance with control of the display control unit 220.

### (Content Viewing Client)

The content viewing client 300 is a client that is connected to the shared server 100 and the content server 400 via a network, and is realized by, for example, an information processing device to be described later. The content viewing client 300 includes, as functional configuration elements, a content acquisition unit 310, a display control unit 320, a display unit 330, and an operation unit 340. More specifically, the content viewing client 300 can be, for example, a PC of a desktop, a notebook, or a tablet type that a user has, a television receiver set, a recorder, a smartphone, or a mobile media player with a network communicating function, or the like, but it is not limited thereto, and can be any of various devices that are capable of having the above-described functional configuration.

The content acquisition unit 310 is realized by operating, for example, a CPU, a RAM, and a ROM in accordance with a program stored in a storage device or a removable recording medium. The content acquisition unit 310 acquires scenario information output from the scenario information generation unit 180 of the shared server 100, and acquires content necessary for reproducing, for example, highlight moving images, thumbnail moving images, or the like that a user desires from the content server 400 based on the scenario information. Further, the content acquisition unit 310 reproduces such highlight moving images and thumbnail moving images using the content acquired based on the scenario information. For example, the content acquisition unit 310 may reproduce such acquired content in an order defined based on the scenario information, or reproduce highlight moving images and thumbnail moving images in a manner of reproducing moving images after seeking only target scenes or representative scenes. In addition, the content acquisition unit 310 may arrange the acquired content in an order defined based on the scenario information, generate highlight moving images and thumbnail moving images using an editing process in which only target scenes or representative scenes are cut out in the case of moving images, and then reproduce the highlight and thumbnail moving images. The content acquisition unit 310 provides the display control unit 320 with the reproduced moving image data.

The display control unit 320 is realized by operating, for example, a CPU, a RAM, and a ROM in accordance with a program stored in a storage device or a removable recording medium, and controls display of the display unit 330. The display control unit 320 causes the display unit 330 to display highlight moving images provided from the content acquisition unit 310. In addition, the display control unit 320 acquires event information output from the event information generation unit 150 of the shared server 100, and causes the display unit 330 to display, for example, an event catalog on which content pieces are present based on the event information. Here, event representative images or flip thumbnails output with the event information are displayed with the event catalog. In addition, when a thumbnail moving image is generated for an event, the display control unit 320 causes the thumbnail moving image acquired by the content acquisition unit 310 to be displayed with the event catalog. Note that an example of displaying highlight moving images and an event catalog will be described later. In addition, the display control unit 320 may cause the display unit 330 to display a GUI component operated via the operation unit 340. An example of the GUI component will also be described later.

The display unit 330 is realized as a display device such as an LCD, or an organic EL display that, for example, the content viewing client 300 has as an output device or that is connected to the content viewing client 300 as an externally-connected device. The display unit 330 displays various images in accordance with control of the display control unit 320.

The operation unit 340 is realized by various input devices that are provided in the content viewing client 300 or connected as externally-connected devices, and acquires operations of a user for the content viewing client 300. The operation unit 340 includes, for example, a pointing device such as a touch pad or a mouse, and may provide users with operations with a GUI in cooperation with the display control unit 320 and the display unit 330 as described above.

### (Content Server)

The content server 400 is a server installed on a network, and realized as, for example, an information processing device to be described below. The content server 400 includes, as functional configuration elements, a content DB 410, and a content analysis unit 420.

Note that the content server 400 may not necessarily be realized by a single device. For example, the function of the content server 400 may be realized by incorporating resources that a plurality of devices have via a network. In addition, the content server 400 may not be a separate body from the shared server 100, or may be realized by a device of which at least some functions are the same as those of the shared server 100.

The content DB 410 is realized by, for example, a storage device, and stores content uploaded by a user who provides the content. The stored content is analyzed by, for example, the content analysis unit 420, and the content acquisition unit 310 of the content viewing client 300 has access thereto.

The content analysis unit 420 is realized by operating, for example, a CPU, a RAM, and a ROM in accordance with a program stored in a storage device or a removable recording medium, and analyzes content stored in the content DB 410. The content analysis unit 420 detects a person appearing in images or moving images of content as a subject by, for example, analyzing feature amounts of images. In addition, the content analysis unit 420 may cluster content based on, for example, distribution of dates on which the content was photographed, and specify events in which the content is photographed. The content analysis unit 420 provides the content information acquisition unit 110 of the shared server 100 with the result of analysis as, for example, meta information of content.

### (2-2. Operation of System)

Next, with reference to FIG. 2, an example of an operation of a system 10 according to an embodiment of the present disclosure described above will be further described. Hereinbelow, description will be provided while corresponding functional configuration elements of FIG. 1 to each operation of steps S1 to S11 are shown.

First, a user who provides content uploads images or moving images to a storage using a predetermined application (S1). Note that, since the application for uploading can have the same configuration as that used in uploading of content in the past, corresponding functional configuration elements to those in FIG. 1 described above are not shown. The application may be executed in, for example, the content providing client 200 in the same manner as in sharing setting (S2), or may be executed in a separate device from the client, for example, a digital camera that acquires content. The storage corresponds to the content DB 410 of the content server 400.

Next, the user who provides the content executes sharing in a client device setting using a sharing setting application (S2). With this sharing setting, for example, a target user with whom the content is shared and a target subject that is associated with each target user are set. Herein, in the present embodiment, the target subject is a person of which face clusters are generated in image analysis (face clustering) of content pieces that are captured and accumulated by that time. Note that the sharing setting application is an application provided via, for example, the operation unit 210, the display control unit 220, and the display unit 230 of the content providing client 200.

The result of sharing setting is reflected in a user DB and a group DB on the server side. Herein, the user DB stores, for example, information of target users set by a user. In addition, the group DB stores information of target subjects associated with each group of the target users set by the user to be described later. Note that the above-described sharing setting may be executed after uploading of images and moving images and content analysis.

On the other hand, content analysis is executed on the server side for uploaded images or moving images (S3). The content analysis executed herein can include, for example, detection of subjects based on analysis of feature amounts of images and specification of events by clustering them based on distribution of dates on which the content was photographed. Content analysis corresponds to, for example, the function of the content analysis unit 420 of the content server 400.

The result of the above-described content analysis (S3) is input to a content DB as meta information of the content (S4). The input of this meta information corresponds to, for example, the function of the content information acquisition unit 110 of the shared server 100.

Herein, the content DB stores, for example, meta information of each content piece. Information stored in the content DB, the user DB, and the group DB by that time is combined using, for example, the ID of the user who provides the content as a key, and used by a scenario creation module (S5). The scenario creation module corresponds to, for example, the functions of the content classification unit 120, the content extraction unit 140, the event information generation unit 150, the frame/scene extraction unit 160, the thumbnail image extraction unit 170, and the scenario information generation unit 180 of the shared server 100.

First, the scenario creation module generates event information (S6). As described above, the event information is information of presenting an event including content in which a target subject associated with a target user appears to the target user who views the content. The target user who views the content acquires the event information using a scenario player application (S7). Note that the scenario player application is an application provided via, for example, the content acquisition unit 310, the display control unit 320, the display unit 330, and the operation unit 340 of the content viewing client 300.

With regard to this, the target user who views the content selects a desired event from the event information using the scenario player application. The scenario creation module generates a scenario of, for example, a highlight moving image (S8). The scenario player application acquires the generated scenario (S9), and accesses the content stored in the storage based on the scenario (S10). Further, the scenario player application generates a desired moving image of a user such as a highlight moving image from the accessed content and reproduces the moving image (S11).

### (3. Sharing Setting)

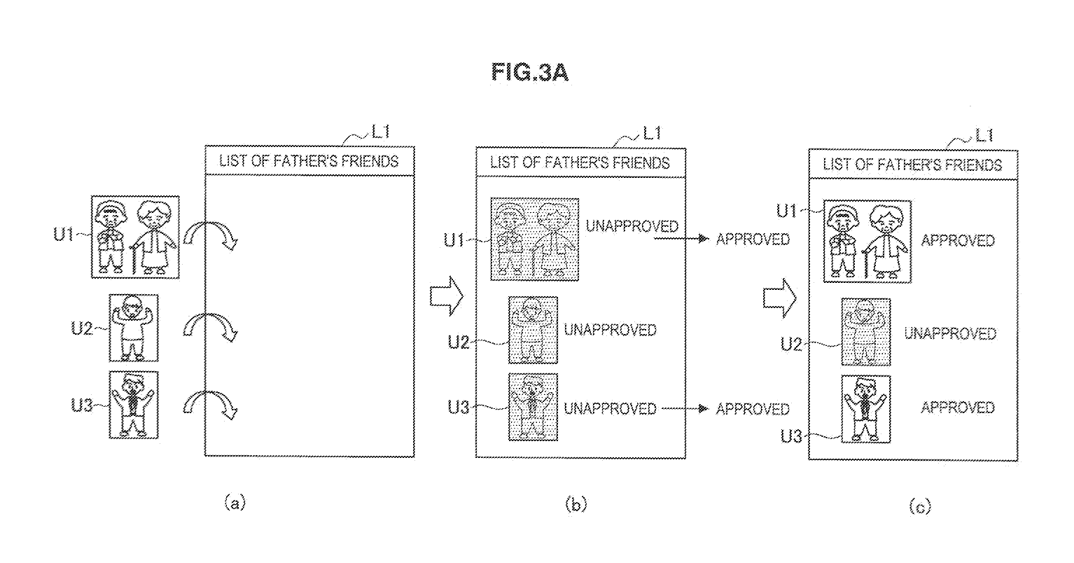

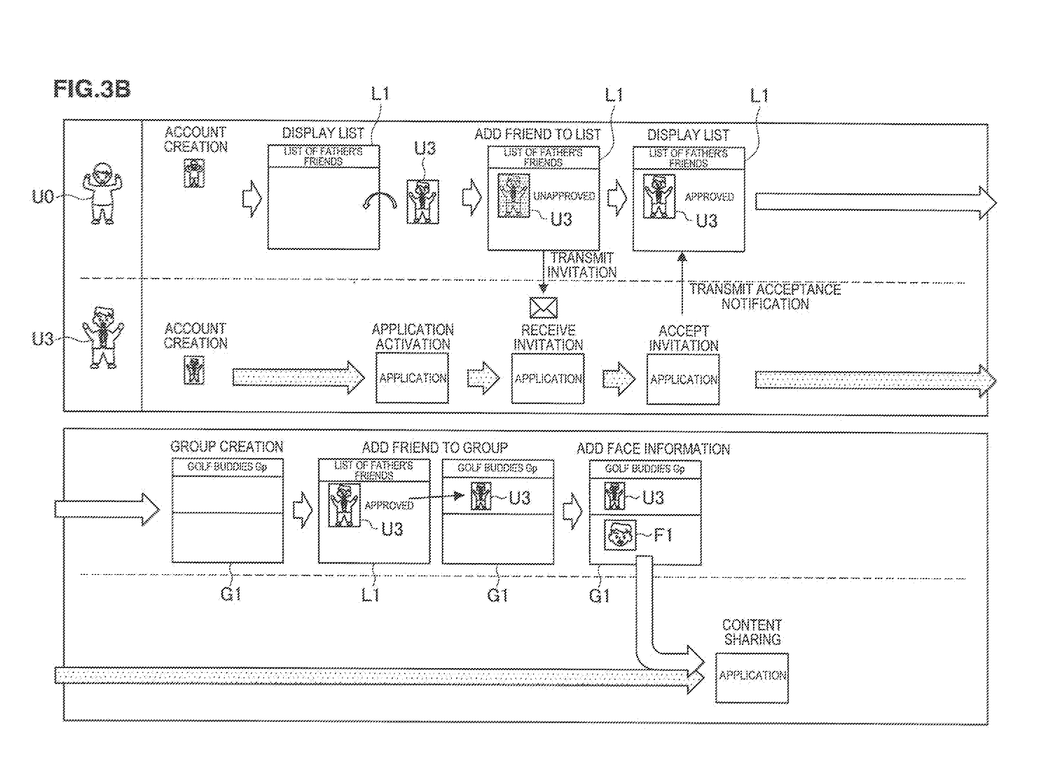

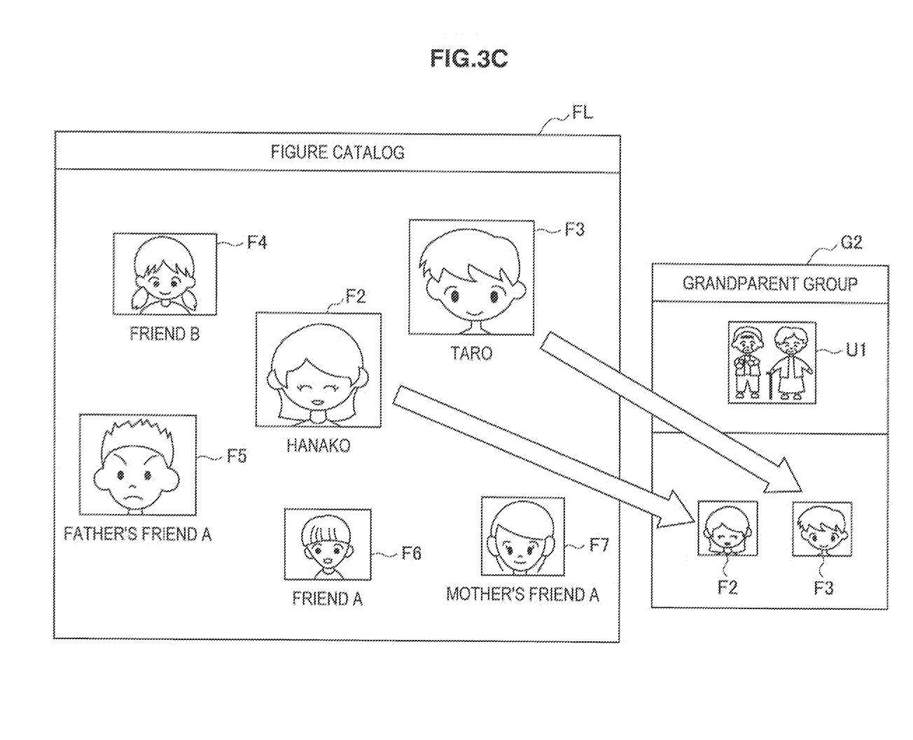

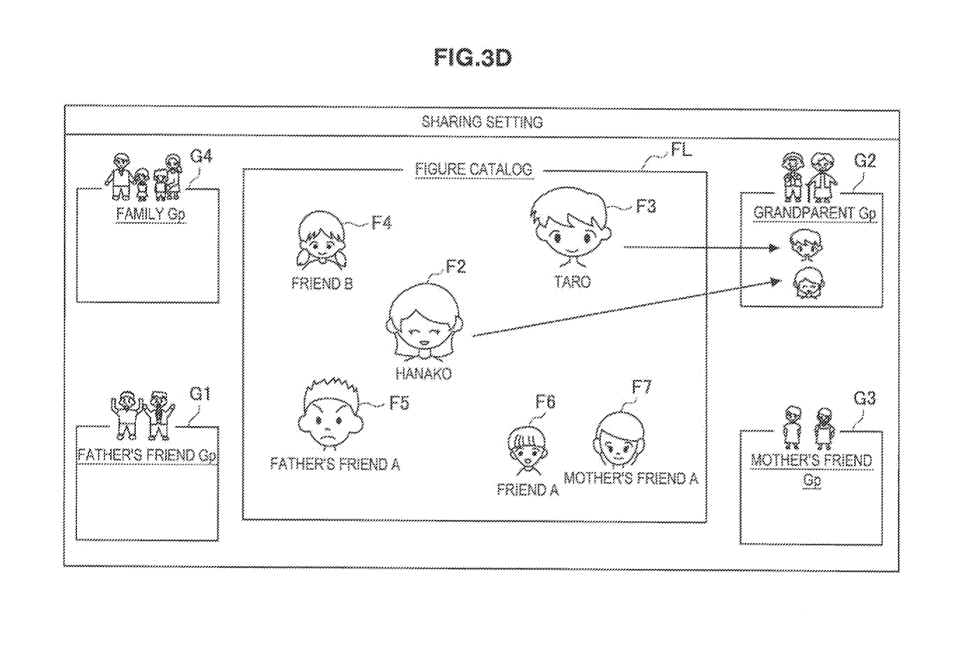

Next, with reference to FIGS. 3A to 3D, sharing setting according to an embodiment of the present disclosure will be described. FIGS. 3A to 3D are diagrams showing examples of sharing setting according to the embodiment of the present disclosure.

Sharing setting is executed using a sharing setting application provided via the operation unit 210, the display control unit 220, and the display unit 230 of the content providing client 200 in, for example, the system 10 described with reference to FIG. 1. Thus, the procedure of sharing setting described in the example below can use, for example, a GUI that is displayed on the display unit 230 by the display control unit 220 and operated via the operation unit 210. In addition, sharing setting described herein corresponds to the sharing setting (S2) in the operation described with reference to FIG. 2.

FIG. 3A shows an example of the procedure for setting target users with whom content is shared. In the example shown in the drawing, users U included on a target user list L1 are set to be target users. First, as shown in (a) of FIG. 3A, users U1 (grandparents), U2 (friend A of father), and U3 (friend B of father) are added on the target user list L1 (friend list of father). In this embodiment, approval of users to be added is necessary for addition onto the target user list L1, in other words, setting as a target user. Thus, as shown in (b) of FIG. 3A, immediately after the addition, all of the users U1 to U3 on the target user list are displayed as unapproved users. Then, when the users U1 (grandparents) and U3 (friend B of father) approve to be added on the target user list L1, the users U1 (grandparents) and U3 (friend B of father) on the target user list L1 are displayed as approved users as shown in (c) of FIG. 3A.

FIG. 3B shows an example of a procedure of setting and grouping target users. In the example shown in the drawing, first, each of a user U0 (father=user who executes sharing setting) and the user U3 (friend B of father) creates an account of a service in which sharing of content is provided. Next, as described with reference to FIG. 3A, the user U0 displays the target user list L1 (friend list of father), and adds the user U3 thereon. At this moment, the user U3 on the target user list L1 is displayed as an unapproved user.

On the other hand, the sharing setting application transmits a notification (invitation) that the user U3 has been added to the target user list L1 by the user U0 to the user U3. The user U3 receives this invitation using an appropriate application and accepts it. The sharing setting application, which has received a notification of acceptance, validates the user U3 added on the target user list L1. In other words, the user U3 on the target user list L1 is displayed as an approved user.

Next, the user U0 creates a target user group G1 (golf buddy Gp), and adds the user U3 from the target user list L1 to this group G1. Accordingly, the user U3 is classified to the target user group G1. Further, the user U0 adds information of a figure F1 (friend B of father, that is, the user U3) to the target user group G1. Note that information of a figure added herein is engaged with a target subject associated with target users classified in the target user group G1. Accordingly, the user U3 (friend B of father) can share content in which the figure F1, that is, the user U3 himself or herself, appears using an appropriate application among content set to be shared by the user U0 (father).

Note that the above described procedure can be appropriately modified, for example, by applying other applications. For example, the target user list L1 may be created by a user as described above, or may also be created by importing friend setting of other services, for example, an SNS (Social Network Service), and the like. Thus, the sharing setting application may not necessarily execute all processes relating to setting of target users shown in the above example.

FIG. 3C shows an example of a procedure of associating information of a figure with a group of target users. In the example shown in the drawing, according to the procedures as shown in FIGS. 3A and 3B above, a target user group G2 (grandparent group) into which the user U1 (grandparents) is classified is set. The sharing setting application provides a GUI that associates information of a desired figure F from a figure list FL (figure catalog) with, for example, the target user group G2. In the example shown in the drawing, figures F2 to F7 are displayed on the figure list FL. A user who executes sharing setting associates information of the figure F with the target user group G2 by, for example, dragging the desired figure F from the figure list FL to the region of the target user group G2.

In the example shown in the drawing, figures F2 (Hanako) and F3 (Taro) are dragged to the region of the target user group G2 (grandparent group). Accordingly, with the user U1 (grandparent) classified as the target user group G2, the figures F2 (Hanako) and F3 (Taro) are associated as target subjects. Accordingly, the user U1 (grandparent) can share content in which the figures F2 (Hanako) and F3 (Taro) appear. In this manner, by grouping target users, it is easy to set subjects to be shared with a plurality of target users. In addition, in the same manner of target users, subjects may be grouped.

FIG. 3D shows another example of a procedure of associating information of a figure with a group of target users. In the example shown in the drawing, according to the procedures as shown in FIGS. 3A and 3B described above, target user groups G1 to G4 are set. In the sharing setting application, it is also possible to set a plurality of target user groups G as above. In such a case, for example, it may also be possible for the target user groups G1 to G4 to be arranged around the figure list FL (figure catalog), and for a user who executes sharing setting to execute an operation of dragging a desired figure F on the figure list FL to a region of any one of the target user groups G.

In the example shown in the drawing, in the same manner as in the example of FIG. 3C, the figures F2 (Hanako) and F3 (Taro) as target subjects are associated with the user U1 (grandparents) who is a target user by dragging the figures F2 (Hanako) and F3 (Taro) to the target user group G2 (grandparent group). The user who executes the sharing setting drags a figure F5 (friend A of father) to, for example, the target user group G1 (friend group of father) in a similar manner. In addition, the figures F2 (Hanako) and F3 (Taro) are dragged to the target user group G4 (family group). In this manner, setting of a figure F as a target subject may differ depending on target user groups G, or all or a portion thereof may overlap.

### (4. Process in Shared Server)

### (4-1. Overview)

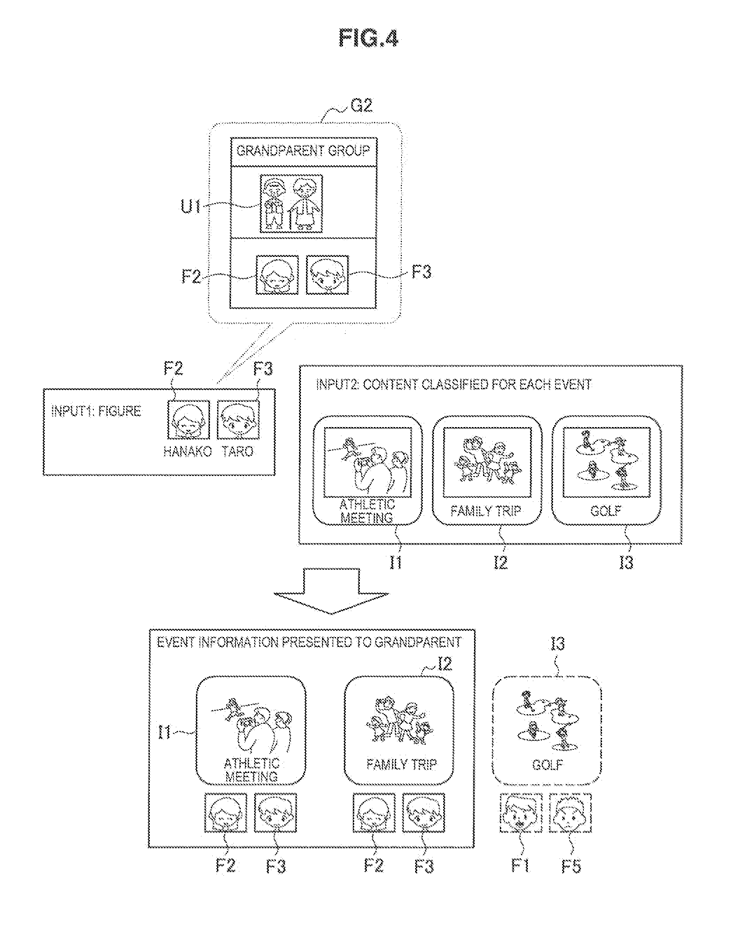

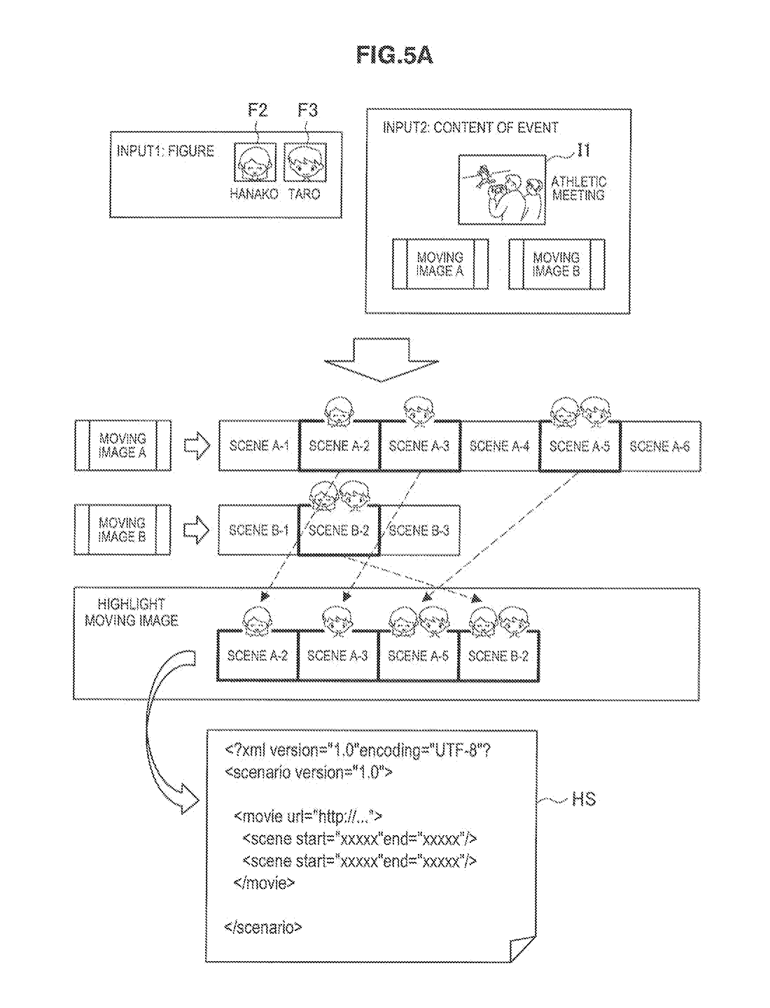

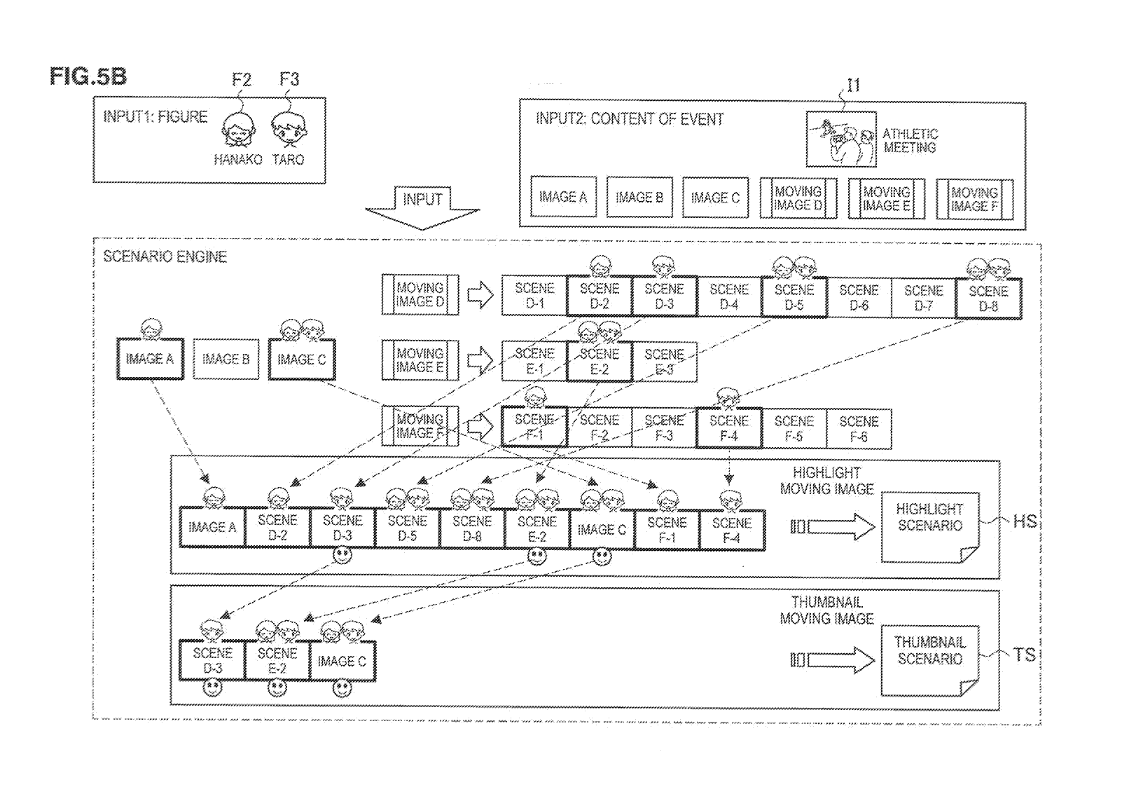

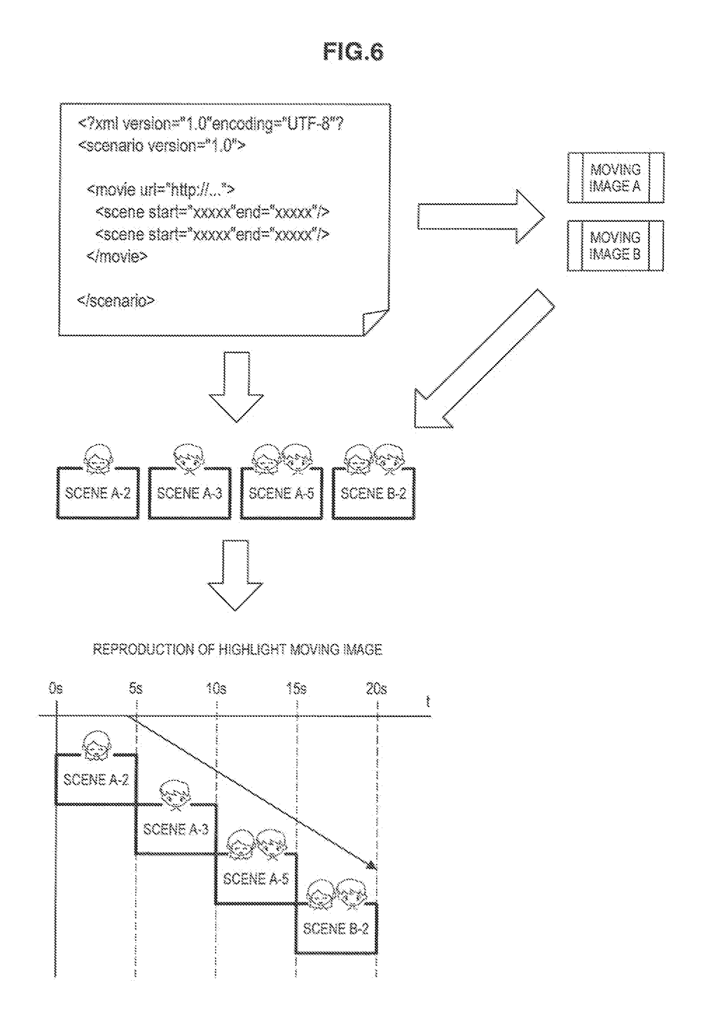

Next, with reference to FIGS. 4 to 6, the overview of a process in the shared server 100 according to an embodiment of the present disclosure will be described. FIG. 4 is a diagram for describing event information according to an embodiment of the present disclosure. FIGS. 5A and 5B are diagrams for describing scenario information according to an embodiment of the present disclosure. FIG. 6 is a diagram for describing reproduction of content using scenario information according to an embodiment of the present disclosure.

### (Process Relating to Event Information)

FIG. 4 shows a process relating to event information. The process shown in the drawing corresponds to the functions of the content classification unit 120, the content extraction unit 140, and the event information generation unit 150 of the shared server 100 in the system 10 described with reference to FIG. 1. In addition, the process shown in the drawing corresponds to the generation of the event information (S6) and the acquisition of the event information (S7) in the operation described with reference to FIG. 2.

In the example shown in the drawing, event information for the user U1 (grandparents) is generated. With the target user group G2 (grandparent group) to which the user U1 belongs, the figures F2 (Hanako) and F3 (Taro) are associated. In other words, with the user U1 who is a target user, the figures F2 and F3 are associated as target subjects. In the shared server 100, the sharing-related information acquisition unit 130 acquires such information. Such information of the figures F2 and F3 (information of the target subjects) can be a first input for generating event information.

On the other hand, for example, content provided by the user U0 (father=user who executes sharing setting) is clustered by, for example, the content analysis unit 420 described in FIG. 1. In the example shown in FIG. 4, content is clustered into three events I1 to I3. In the shared server 100, the content classification unit 120 classifies content according to a result of clustering. The content classified into events I1 to I3 as above can be a second input for generating event information.

Using these inputs, event information Iinfo for the user U1 (grandparents) is generated. In the shared server 100, the content extraction unit 140 first extracts content pieces in which the figures F2 (Hanako) and F3 (Taro) are included as subjects from the content classified into events I1 to I3. As a result, from the events I1 (athletic meeting) and I2 (family trip), content pieces in which the figures F2 (Hanako) and F3 (Taro) are included as subjects are extracted. On the other hand, from the event I3 (golf), only content pieces in which the figures F0 (father) and F5 (friend A of father) are included as subjects are extracted.

Receiving this result, the event information generation unit 150 generates the event information Iinfo including the information of the events I1 (athletic meeting) and I2 (family trip), and presents the information to the user U1 (grandparents) via the content viewing client 300. Accordingly, the user U1 can view the content in which the subjects of interest (Hanako and Taro) appear by selecting in units of events with ease.

Note that, as described above, the event I included in the event information Iinfo may be limited by setting of, for example, the user U0 (father=user who executes sharing setting). When, for example, the event I2 (family trip) is a secret event for the user U1 (grandparents), the user U0 can also set so that the event information Iinfo presented to the user U1 does not include the event I2. In order to attain such setting, in the content providing client 200, for example, a preview function of event information for each target user may be provided.

### (Process Relating to Scenario Information)

FIG. 5A shows a process relating to scenario information. The process shown in the drawing corresponds to the functions of the content extraction unit 140, the frame/scene extraction unit 160, and the scenario information generation unit 180 of the shared server 100 in the system 10 described with reference to FIG. 1. In addition, the process shown in the drawing corresponds to the generation of the scenario (S8) and the acquisition of the scenario (S9) in the operation described with reference to FIG. 2.

In the example shown in the FIG. 5A, as a continuation of the example of event information described above, scenario information for the user U1 (grandparents) is generated. With the user U1 (grandparents) who is a target user, the figures F2 and F3 are associated as target subjects. In the shared server 100, the sharing-related information acquisition unit 130 acquires such information. Such information of the figures F2 and F3 (information of the target subjects) can be a first input for generating scenario information.

On the other hand, it is assumed that, for example, the user U1 (grandparents) who is presented with the events I1 (athletic meeting) and I2 (family trip) as the event information Iinfo selects the event I1 (athletic meeting) therefrom. In this case, the content extraction unit 140 and the frame/scene extraction unit 160 execute a process for content which belongs to the event I1. In the example shown in the drawing, moving image A and moving image B are shown as two content pieces which belongs to the event I1. Such content pieces to which the event I1 belongs can be second inputs for generating scenario information.

Using these inputs, the frame/scene extraction unit 160 extracts scenes in which at least any one of the figures F2 and F3 appears from the moving images A and B. As shown in the drawing, scenes A-2, A-3, and A-5, and a scene B-2 are extracted respectively from the moving image A and the moving image B. The scenario information generation unit 180 composes a highlight moving image by combining these scenes.

In the example shown in the drawing, however, the scenario information generation unit 180 outputs this highlight moving image as a highlight scenario HS, rather than outputting as it is. The highlight scenario HS is information used by the content viewing client 300 in order to obtain the highlight moving image by accessing the content as will be described below. In the example shown in the drawing, the highlight scenario HS is shown as a file in an xml format indicating the address of the content and the positions of the start and the end of the scenes, but the format of the highlight scenario HS may be any kind

FIG. 5B shows the process relating to the scenario information shown in FIG. 5A in more detail. Likewise, as in FIG. 5A, the first input for generating the scenario information is the information of the figures F2 and F3 (information of the target subjects). In addition, the second inputs are content which belongs to the event I1 (athletic meeting). In the example of FIG. 5B, however, six content pieces of images A, B, and C, and moving images D, E, and F belong to the event I1, unlike in the example of FIG. 5A.

Using these inputs, the content extraction unit 140 first extracts content pieces including the figures F2 and F3 as subjects from the content pieces that belong to the event I1. In the example shown in the drawing, the figures F2 and F3 are included in the images A and C, and the moving images D, E, and F as subjects. Thus, the content extraction unit 140 extracts the images A and C, and the moving images D, E, and F as target content pieces. On the other hand, the image B that does not include the figures F2 and F3 as subjects is not used in the following processes relating to scenario information generation.

Next, the frame/scene extraction unit 160 extracts scenes in which the figures F2 and F3 appear for the moving images D, E, and F. In the example shown in the drawing, scenes D-2, D-3, D-5, and D-8, a scene E-2, and scenes F-1 and F-4 are extracted respectively from the moving image D, the moving image E, and the moving image F.

In the example shown in the drawing, the scenario information generation unit 180 generates two kinds of scenario information from the extracted images and scenes described above. One is the highlight scenario HS described also in FIG. 5A above. The highlight scenario HS is a scenario for obtaining a highlight moving image in which the extracted images and scenes are all arranged in order, for example, in a time series, or the like.

The other one is a thumbnail scenario TS. The thumbnail scenario TS is a scenario for obtaining a thumbnail moving image by further extracting images and scenes that satisfy predetermined conditions from the extracted images and scenes above, and arranging them therein. In the example shown in the drawing, from the extracted images and scenes, scenes D-3 and E-2, and the image D which are an image and scenes (marked by smile symbols) in which the figures F2 and F3 appearing therein have a high degree of smile are extracted so as to compose a thumbnail moving image.

### (Reproduction of Content Using Scenario Information)

FIG. 6 shows a process of reproducing content using the scenario information output in, for example, the process as shown in FIG. 5A. The process shown in FIG. 6 corresponds to the function of the content acquisition unit 310 of the content viewing client 300 in the system 10 described with reference to FIG. 1. In addition, the process shown in the drawing corresponds to the access to content (S10) and the reproduction (S11) in the operation described with reference to FIG. 2.

In the example shown in FIG. 6, based on the highlight scenario HS that is scenario information, a highlight moving image including scenes A-2, A-3, and A-5 of the moving image A and the scene B-2 of the moving image B is defined. The content acquisition unit 310 that acquires the highlight scenario HS accesses the content substance of the moving images A and B stored in, for example, the content server 400 so as to acquire a moving image including scenes designated by the highlight scenario HS. Further, the content acquisition unit 310 provides the display control unit 320 with a moving image obtained by arranging the acquired scenes on the time axis as shown in the drawing, by seeking and reproducing the designated scenes, and accordingly, the highlight moving image is displayed on the display unit 330.

Note that, herein, the content acquisition unit 310 may reproduce the highlight moving image by acquiring, for example, the moving images A and B from the content server 400 as a whole, and executing an editing process of the moving images on the client side. Alternatively, the content acquisition unit 310 may transmit the highlight scenario HS to the content server 400 so that the moving images are edited on the content server 400 side based on the scenario and then provided to the content viewing client 300 using, for example, streaming.

### (4-2. Details)

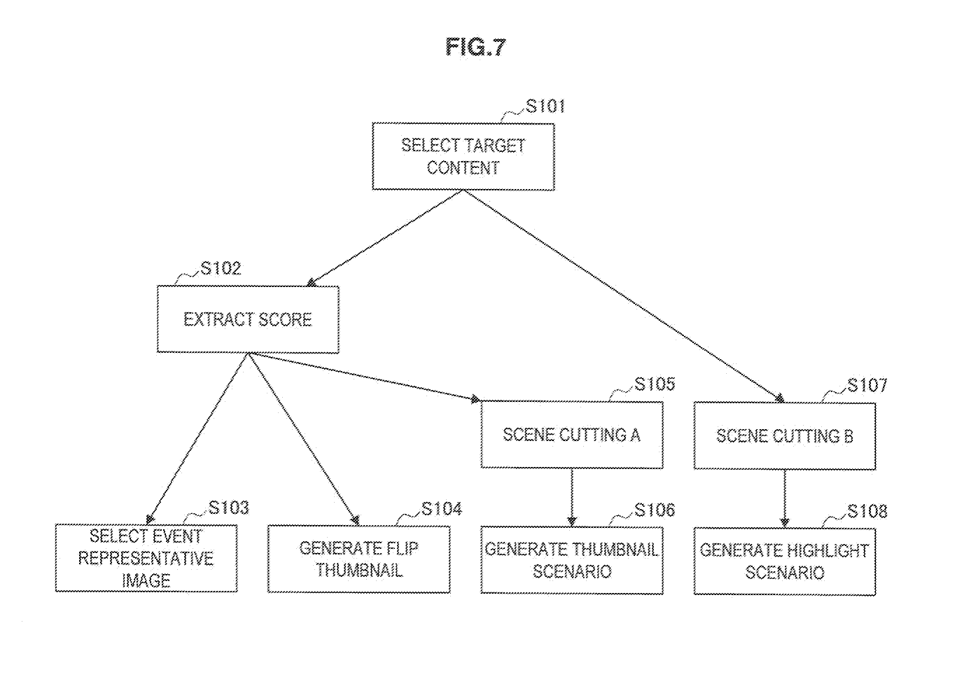

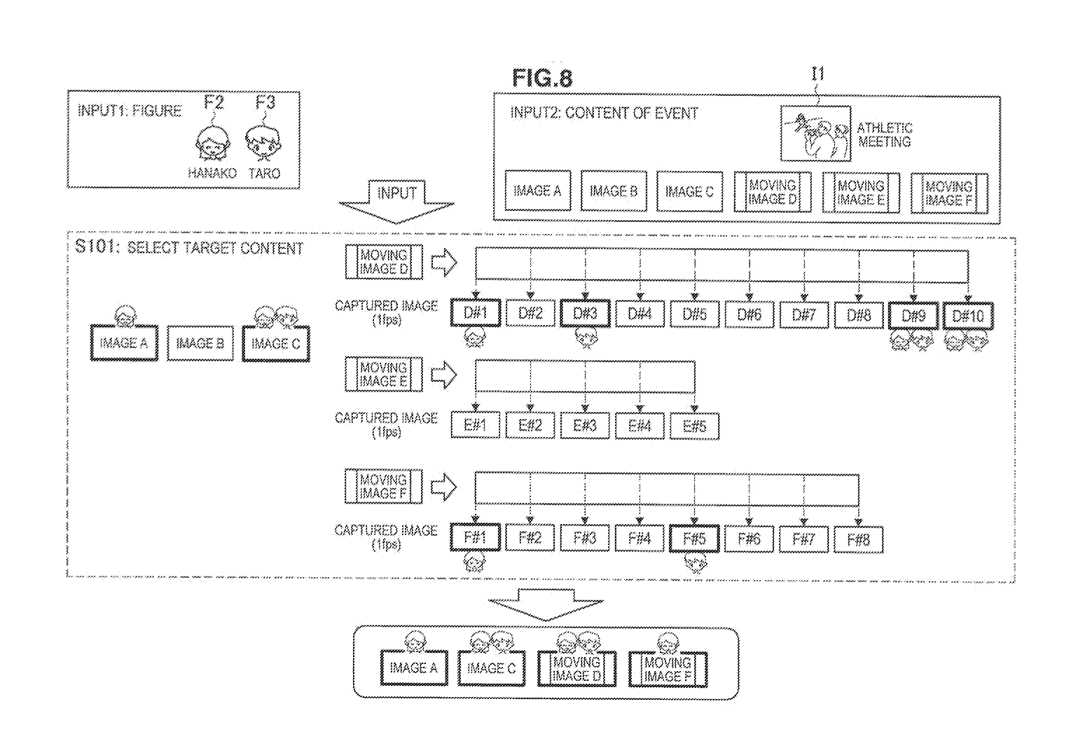

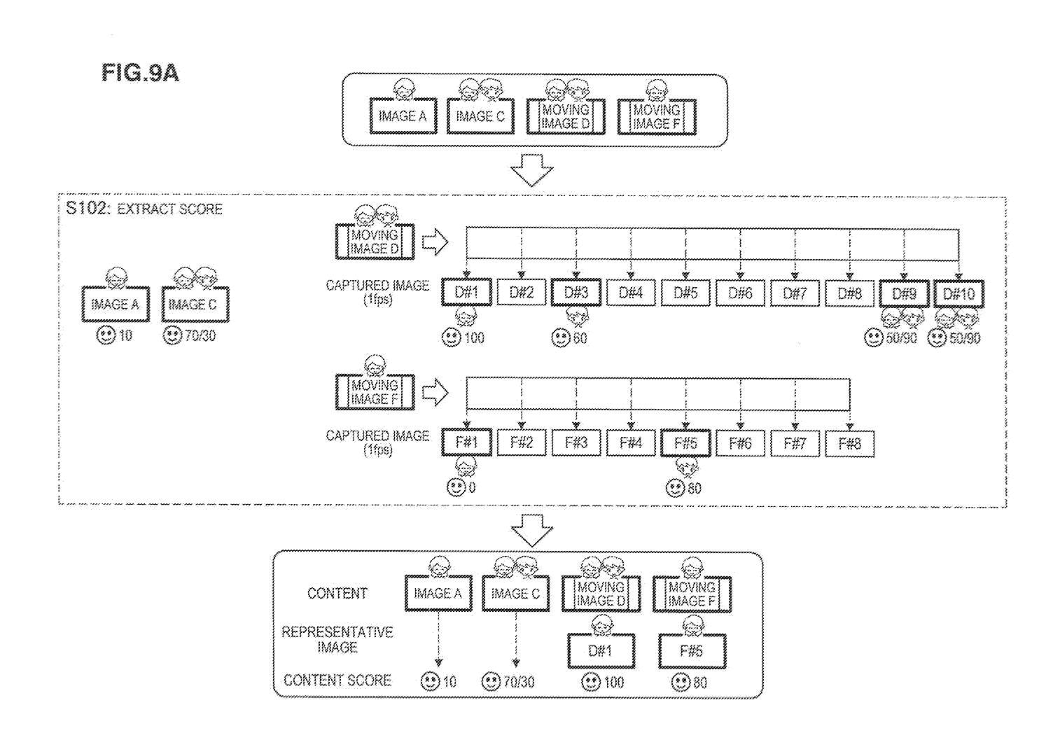

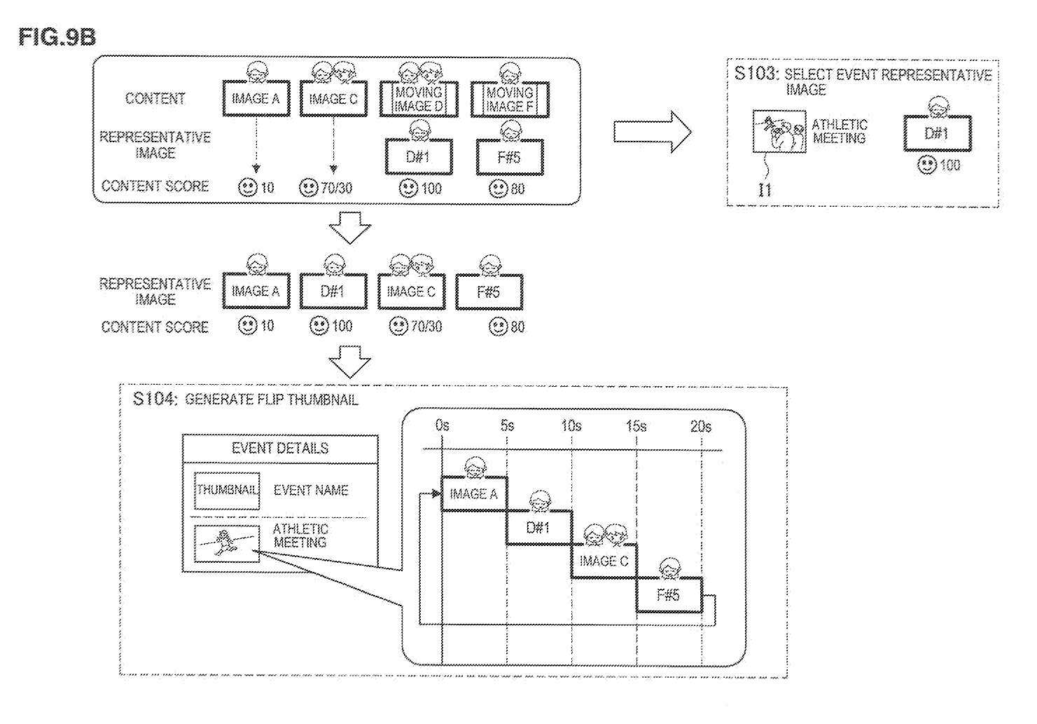

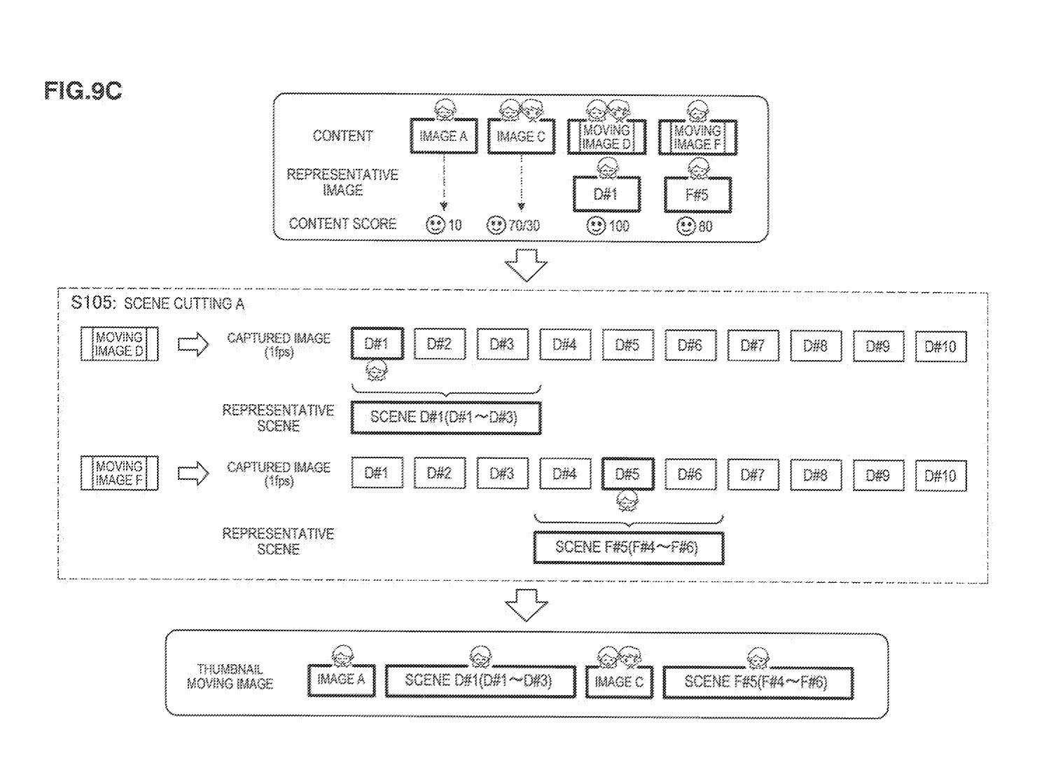

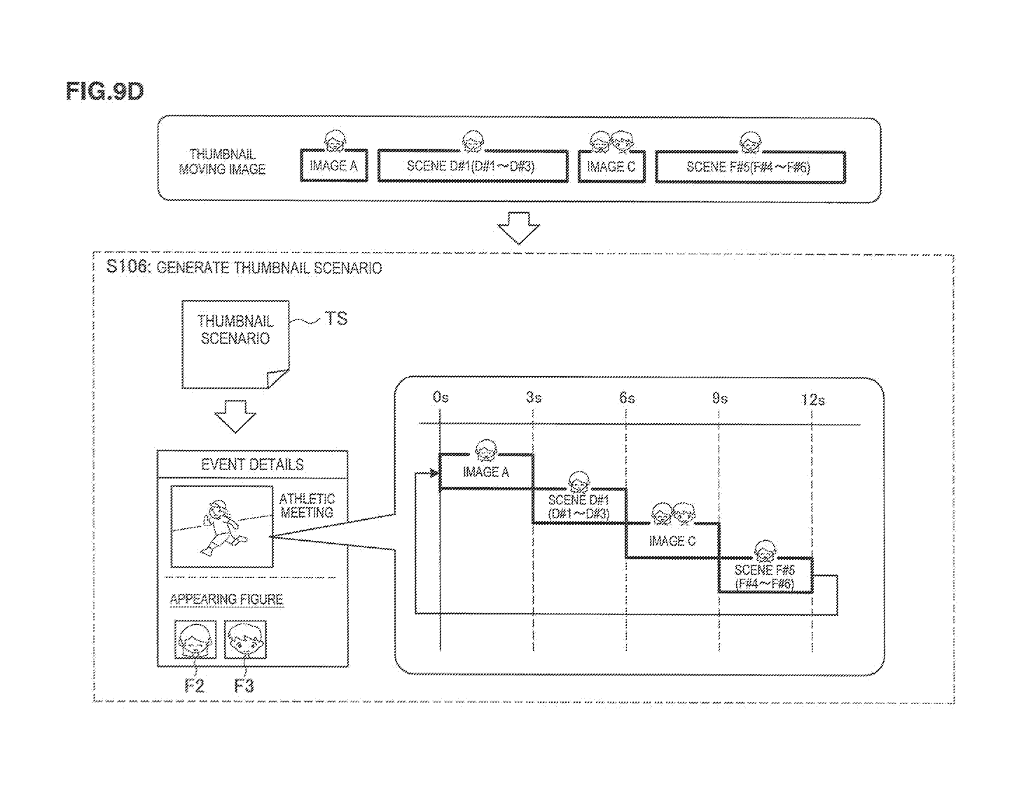

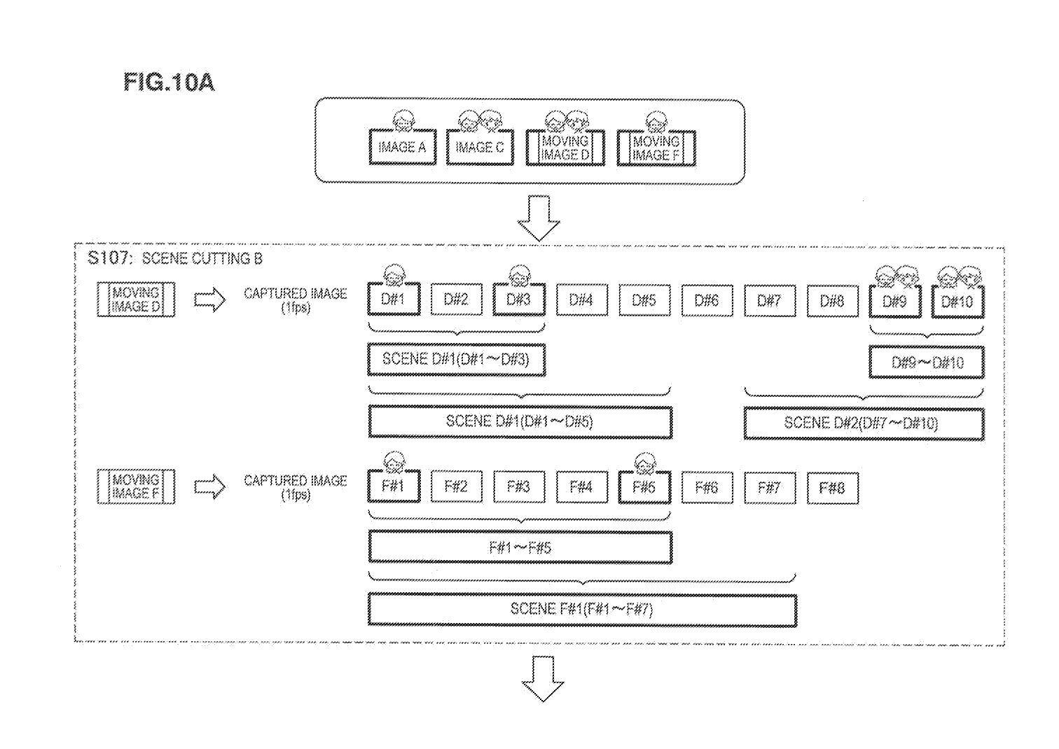

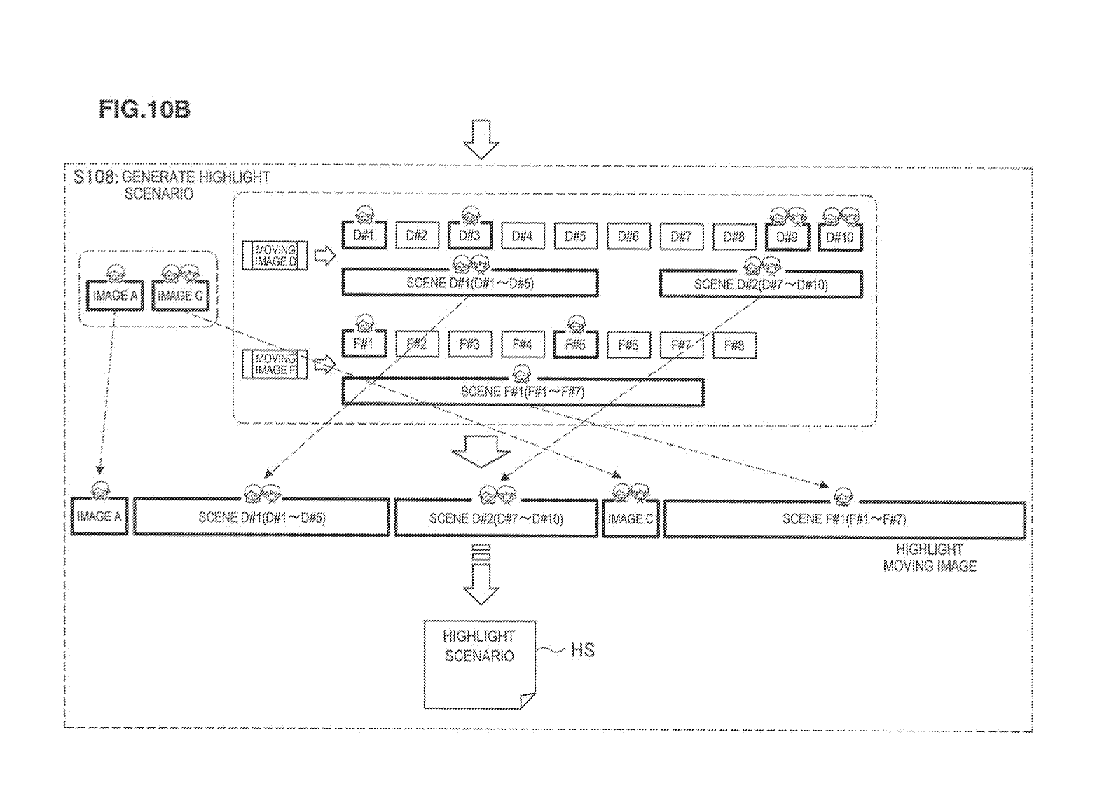

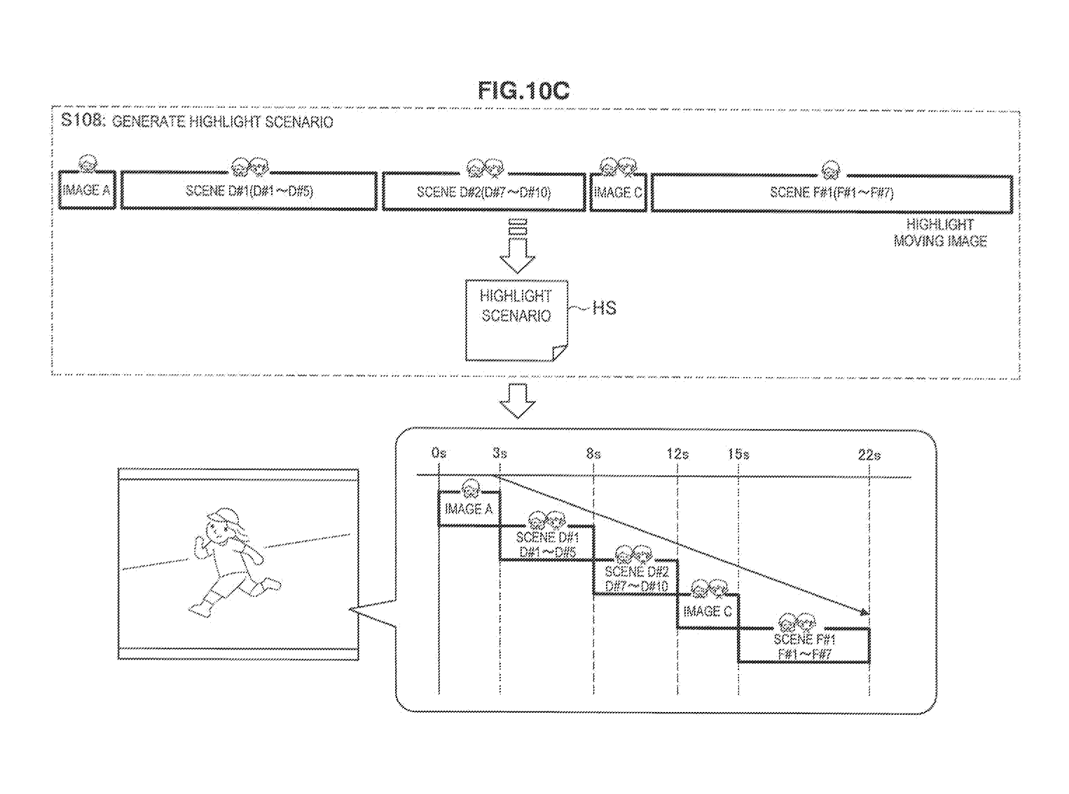

Next, with reference to FIGS. 7 to 10C, details of a process in the shared server 100 according to an embodiment of the present disclosure will be described. FIG. 7 is a diagram for describing generation of scenario information and a thumbnail image according to an embodiment of the present disclosure. FIG. 8 is a diagram for describing selection of target content according to an embodiment of the present disclosure. FIGS. 9A to 9D are diagrams for describing generation of a thumbnail image and a thumbnail scenario according to an embodiment of the present disclosure. FIGS. 10A to 10C are diagrams for describing generation of a highlight scenario according to an embodiment of the present disclosure.

### (Regarding Generation of Thumbnail Image and Scenario Information)

FIG. 7 shows the flow of all processes described with reference to FIGS. 8 to 10C hereinbelow, and reference numerals (S101 to S108) of the process of FIG. 7 correspond to those of each process in FIGS. 8 to 10C.

Referring to FIG. 7, first, when one image or frame (event representative image) is to be output as a thumbnail image, the content extraction unit 140 selects target content (S101), and the frame/scene extraction unit 160 extracts a score of the extracted target content (S102). Based on the result, the thumbnail image extraction unit 170 selects an event representative image (S103).

In addition, when an animation constituted by a plurality of images or frames (flip thumbnail) is to be output as a thumbnail image, the frame/scene extraction unit 160 extracts a score of target content in the same manner as in the case of the event representative image (S102), and then the thumbnail image extraction unit 170 generates a flip thumbnail (S104).

On the other hand, when a thumbnail scenario is to be generated, the frame/scene extraction unit 160 extracts a score for target content in the same manner as in the above two cases (S102), and then further executes a process of scene cutting A (S105). Based on the result, the scenario information generation unit 180 generates a thumbnail scenario (S106).

In addition, when the highlight scenario is to be generated, the content extraction unit 140 selects target content (S101), and then the frame/scene extraction unit 160 executes a process of scene cutting B (S107). Based on the result, the scenario information generation unit 180 generates a highlight scenario (S108).

### (Regarding Selection of Target Content)

FIG. 8 is a diagram showing an example of the selection of the target content by the content extraction unit 140 (S101) in more detail. In the example shown in the drawing, in the same manner as in the example of FIG. 5B above, the information of the figures F2 and F3 (information of the target content) as the first input is given respectively to six content pieces of the images A to C and the moving images D to F which belong to the event I1 as a second input.

In the selection of the target content (S101), content pieces in which the figures F2 and F3 appear as subjects are picked up from the content given as an input. The content extraction unit 140 acquires information pieces of the subjects appearing in each of the images A to C from, for example, the content information acquisition unit 110, and detects the figures F2 (Hanako) and F3 (Taro) appearing as subjects. In the example shown in the drawing, it is detected that the figure F2 (Hanako) appears in the image A and both of the figures F2 (Hanako) and F3 (Taro) appear in the image C.

On the other hand, the content extraction unit 140 acquires captured images (frames) of a predetermined frame rate from each of the moving images D to F, acquires information pieces of the subjects appearing in each of the frames from, for example, the content information acquisition unit 110, and detects the figures F2 and F3 appearing as subjects. In the example shown in the drawing, as a result of acquiring captured images at a frame rate of 1 fps, it is detected that the figure F2 (Hanako) appears in a frame D#1 of the moving image D, the figure F3 (Taro) appears in a frame D#3, and both of the figures F2 (Hanako) and F3 (Taro) appear in frames D#9 and D#10. In addition, it is detected that the figure F2 (Hanako) appears in frames F#1 and F#5 of the moving image F.

As the result of the detection described above, the content extraction unit 140 selects four of the images A and C and the moving images D and F as content pieces in which at least any one of the figures F2 (Hanako) and F3 (Taro) appears. On the other hand, the image B and the moving image E in which none of the figures F2 (Hanako) and F3 (Taro) appears are not used in generation of thumbnail images and scenario information to be continued thereafter. However, the image B and the moving image F are not necessarily limited to be unnecessary content pieces. When another subject (for example, a friend of Hanako) appears in the moving image E, for example, and the target user is the friend of Hanako or Hanako herself, the moving image E can be selected by the content extraction unit 140.

### (Regarding Generation of Thumbnail Image and Thumbnail Scenario)

FIG. 9A is a diagram showing an example of score extraction (S102) by the frame/scene extraction unit 160 in more detail. In the example shown in the drawing, as a continuation of the example of FIG. 8 above, the images A and C, and the moving images D and F selected by the content extraction unit 140 are given as inputs.

In the score extraction (S102), scores in units of content pieces are set for the content pieces given as inputs by a predetermined standard. In the example shown in the drawing, the degree of smile (indicated by a number accompanied with a smile symbol) of the figures F2 (Hanako) and F3 (Taro) included as target subjects is extracted as a score of each content piece. Note that, to detect the degree of smile, all techniques of the related art such as the technique disclosed in, for example, Japanese Unexamined Patent Application Publication No. 2008-311819 are applicable.

In the example shown in the drawing, the frame/scene extraction unit 160 detects the degree of smile for the images A and C as they are, and sets the degree of smile as a score of the content pieces. On the other hand, for the moving images D and F, captured images (frames) at a predetermined frame rate are acquired in the same manner as the process in the content extraction unit 140, and the detection of the degree of smile is executed for frames in which the target subjects appear. In other words, in the example shown in the drawing, the detection of the degree of smile is executed for the frames D#1, D#3, D#9, and D#10 of the moving image D and the frames F#1 and F#5 of the moving image F among the captured images acquired at a frame rate of 1 fps. The frame/scene extraction unit 160 sets the highest degree among the degrees of smile acquired in each of the frames to be a score of the content piece for each of the moving images.

In addition, in the example shown in the drawing, the frame/scene extraction unit 160 executes the detection of the degree of smile for each of the target subjects when the target subjects are plural. In other words, for the image C and the frames D#9 and D#10 of the moving image D in which both figures of F2 (Hanako) and F3 (Taro) appear, the frame/scene extraction unit 160 detects both degrees of smile of the figure F2 (Hanako) and the figure F3 (Taro). The degree of smile detected in this manner is indicated as, for example, “ 70/30” for the image C. This indicates that the degree of smile of the figure F2 (Hanako) is 70 and the degree of smile of the figure F3 (Taro) is 30.

Based on the result of the score extraction as described above, the frame/scene extraction unit 160 decides scores of each of the content pieces. In addition, when a content piece is a moving image, the frame/scene extraction unit 160 may set a frame corresponding to a score as a representative frame of the content piece. In the example shown in the drawing, the frame/scene extraction unit 160 respectively sets the degree of smile of the figure F2 (Hanako) to be 10 for the image A, the degree of smile of the figures F2 (Hanako)/F3 (Taro) to be 70/30 for the image C, the degree of smile of the figure F2 (Hanako) and the representative frame D#1 to be 100 for the moving image D, and the degree of smile of the figure F3 (Taro) and the representative frame F#5 to be 80 for the moving image F.

Note that, since the scores and representative frames extracted herein affect the selection of images and moving images displayed as, for example, thumbnails, the frame/scene extraction unit 160 may adjust the setting in consideration of, for example, a balance between subjects. For example, the frame/scene extraction unit 160 may preferentially select a frame in which both of the figures F2 (Hanako) and F3 (Taro) are included as a representative frame. In this case, in the moving image D, for example, the frame D#9 or D#10 in which both of the figures F2 (Hanako) and F3 (Taro) appear, rather than the frame D#1 in which the figure F2 (Hanako) appears alone having the high degree of smile, is set to be the representative frame, and the degree of smile of the figures F2 (Hanako)/F3 (Taro) of 50/90 is set to be the score of the content piece.

FIG. 9B is a diagram showing an example of the selection of an event representative image by the thumbnail image extraction unit 170 (S103) and the generation of a flip thumbnail (S104) in more detail. In the example shown in the drawing, as a continuation of the example of FIG. 9A described above, information of the scores and the representative frames of the content pieces (the images A and C, and the moving images D and F) set by the frame/scene extraction unit 160 is given as an input.

In the selection of an event representative image (S103), an image or a frame of a moving image having the highest score set by the frame/scene extraction unit 160 is set to be a representative image of an event. In the example shown in the drawing, the degree of smile of the figure F2 (Hanako) of 100 in the representative frame D#1 of the moving image D is the highest score. Thus, the thumbnail image extraction unit 170 selects this frame D#1 as a representative image of the event I1 (athletic meeting). As described above, such an event representative image can be displayed with event information in, for example the content viewing client 300.

On the other hand, in the generation of a flip thumbnail (S104), an animation by which images and representative frames of moving images for which scores are set by the frame/scene extraction unit 160 are sequentially displayed is generated. In the example shown in the drawing, the image A, the frame D#1 (representative frame) of the moving image D, the image C, and the frame F#5 (representative frame) of the moving image F are sequentially displayed every 5 seconds in the flip thumbnail. Note that the time by which each of the images is displayed may not necessarily be 5 seconds. In addition, these images may be repeatedly displayed. In the same manner as an event representative image, a flip thumbnail can also be displayed with event information in, for example, the content viewing client 300.

FIG. 9C is a drawing showing an example of the process of scene cutting A (S105) by the frame/scene extraction unit 160 in more detail. In the example shown in the drawing, as a continuation of the example of FIG. 9A described above, information of the scores and representative frames of the content pieces (the images A and C and the moving images D and F) set by the frame/scene extraction unit 160 is given as an input.

In the process of scene cutting A (S105), a section before and after a representative frame is cut out as a representative scene for content of moving images (the moving images D and F). In the example shown in the drawing, as rules of scene cutting, for example, the following is set.
When frames in which a target subject appears are continuative, these frames are treated as an integrated frame group.
When the time interval between a frame in which a target subject appears and the next frame in which the target subject appears (a different target subject may appear) is shorter than or equal to 2 seconds, these frames may be treated as an integrated frame group.
A section including one second before and after a frame or a frame group in which a target subject appears is cut out as one scene.
When the time of one scene is set to be three seconds at the minimum, and a frame in which a target subject appears is a leading frame or a final frame, a section including two seconds before and after the frame is cut out.

In the example shown in the drawing, since the unit of scene cutting is set to be one second, it is possible to determine scene cutting using captured images acquired at a frame rate of 1 fps in the same manner as in the selection of target content, or the like, described above. When, for example, the unit of scene cutting is set to be 0.1 seconds, determination of scene cutting can be executed using captured images acquired at a frame rate of 10 fps.

For the moving image D, since the leading frame D#1 is a representative frame, a section of three seconds from the frame D#1, in other words, the frames D#1 to D#3, are set to be a representative scene D#1. In addition, for the moving image F, since the frame F#5 in the middle is a representative frame, a section of three seconds including one second before and after the frame F#5, in other words, the frames F#4 to F#6, are set to be a representative scene F#5.

Note that a range of a representative scene is set using captured images of a predetermined frame rate as described above, but an actual representative scene is a section of a moving image corresponding to the captured images. In other words, the representative scene D#1 is not regarded as three frames, but a portion of the moving image constituted by, for example, a series of the whole frames from the frame D#1 to the frame D#3.

A thumbnail moving image is obtained by arranging each of the representative scenes D#1 and F#5 of the moving images D and F acquired in the process of scene cutting A as described above and the images A and C selected in the selection of target content (S101) in, for example, a time series.

FIG. 9D is a diagram showing an example of the generation of a thumbnail scenario by the scenario information generation unit 180 (S106) in more detail. In the example shown in the drawing, as a continuation of the example of FIG. 9C described above, the images A and C and each of the representative scenes D#1 and F#5 of the moving images D and F are given as an input.

The scenario information generation unit 180 defines a thumbnail moving image by arranging these content pieces in, for example, a time series. Further, the scenario information generation unit 180 generates a thumbnail scenario TS corresponding to the thumbnail moving image. The thumbnail scenario TS may be a file in an xml format indicating the address of content and positions of the start and the end of scenes, in the same manner as, for example, the example of highlight scenario HS described above, but the file format is not limited thereto.

The generated thumbnail scenario TS is output to the content viewing client 300. By acquisition of content in accordance with the thumbnail scenario TS by the content acquisition unit 310 of the content viewing client 300, the thumbnail moving image as shown in the drawing is reproduced.

In the example of the thumbnail moving image shown in the drawing, after the image A is displayed for three seconds, the scene D#1 is reproduced, the image C is further displayed for three seconds, and finally the scene F#5 is reproduced. Note that, in the thumbnail moving image, the time for which an image is displayed may not necessarily be three seconds, but in the example shown in the drawing, since the length of both scenes of D#1 and F#5 is three seconds, the images A and C are also displayed for three seconds in accordance with the time. In addition, the thumbnail image may be repeatedly reproduced.

In addition, as shown in the drawing, the thumbnail image can be displayed with event information (event details) in, for example, the content viewing client 300, but at this time, information of the subjects (appearing people) included in the content may be displayed together. In the example shown in the drawing, the faces of the figures F2 and F3 are displayed.

### (Regarding Generation of Highlight Scenario)

FIG. 10A is a diagram showing an example of the process of scene cutting B (S107) by the frame/scene extraction unit 160 in more detail. In the example shown in the drawing, as a continuation of the example of FIG. 8 described above, the images A and C and the moving images D and F selected by the content extraction unit 140 are given as an input.

In the process of scene cutting B (S107), for the content of moving images (the moving images D and F), a section in which a target subject appears is cut out as a representative scene. In the example shown in the drawing, as rules of cutting out a scene, for example, the following is set (differences between the rules in the scene cutting A are shown in brackets < >).
When frames in which a target subject appears are continuative, these frames are treated as an integrated frame group.
When the time interval between a frame in which a target subject appears and the next frame in which the target subject appears (a different target subject may appear) is shorter than or equal to <5 seconds>, these frames may be treated as an integrated frame group.
A section including <two seconds> before and after a frame or a frame group in which a target subject appears is cut out as one scene.

A highlight moving image is generated as an object that a user views, unlike a thumbnail moving image generated in order to organize content briefly. For this reason, it is desirable that a highlight moving image include a sufficient portion of interest of a user who views the content. Therefore, as described in the example above, the criterion of scene cutting may be different from that of a thumbnail moving image.

In a moving image, for example, if only a frame in which a target subject is shown is cut as a scene, there is a possibility that a fragmented unnatural highlight moving image is generated. Thus, in the process of scene cutting B for a highlight moving image, the interval of frames for treating the frames in which a target subject appears as an integrated frame group and the shortest length of one scene can be set longer than those in a thumbnail moving image. Accordingly, a portion in which a target subject appears but is not recognized as a person, for example, a case in which a target subject appears but is not recognized in image analysis, in which a target subject faces backward, or the like, can be included in a scene to be cut.

In the example shown in the drawing, in accordance with the rules described above, in the moving image D, the frames D#1 and D#3 are treated as an integrated frame group, and a section from the frame D#1 to the frame D#5 two seconds after the frame D#3 is cut as a scene D#1. In addition, the frames D#9 and D#10 are treated as an integrated frame group, and a section from the frame D#7 two seconds before the frame D#9 to the frame D#10 is cut out as a scene D#2. On the other hand, in the moving image F, the frames F#1 and F#5 are treated as an integrated frame group, and a section from the frame F#1 to the frame F#7 two seconds after the frame F#5 is cut out as a scene F#1.

Note that the range of a scene to be cut out herein is set by captured images of a predetermined frame rate as described above, but an actual scene is a section of a moving image corresponding to the captured images. In other words, the scene D#1 is not regarded as five frames, but a portion of the moving image constituted by, for example, a series of all of the frames from the frame D#1 to the frame D#5.

FIGS. 10B and 10C are drawings showing an example of the generation of a highlight scenario by the scenario information generation unit 180 (S108) in more detail. In the example shown in the drawings, as a continuation of the example of FIG. 10A described above, the images A and C, the scenes D#1 and D#2 cut out from the moving image D, and the scene F#1 cut out from the moving image F are given as an input.

As shown in FIG. 10B, the scenario information generation unit 180 defines a highlight moving image by arranging the content pieces in, for example, a time series. Further, the scenario information generation unit 180 generates a highlight scenario HS corresponding to a highlight moving image. The highlight scenario HS may be, for example, a file in an xml format indicating the address of content and positions of the start and the end of scenes, but the file format is not limited thereto.

As shown in FIG. 10C, the generated highlight scenario HS is output to the content viewing client 300. The content acquisition unit 310 of the content viewing client 300 generates a highlight moving image as shown in the drawing by acquiring content in accordance with the highlight scenario HS.

In the example of the highlight moving image as shown in the drawing, after the image A is displayed for three seconds, the scene D#1 is reproduced, then the scene D#2 is reproduced, the image C is displayed for three seconds, and finally the scene F#1 is reproduced. Note that, in the highlight moving image, the time for which an image is displayed may not necessarily be three seconds. The time for which an image is displayed may be dynamically set according to, for example, the length of a scene of a moving image to be included together, or the length of the entire highlight moving image. Note that, since a highlight moving image is viewed after, for example, being selected by a user based on his or her own intention, the highlight moving image is not repeatedly reproduced in many cases, unlike a thumbnail moving image.

### (5. Display During Content View)

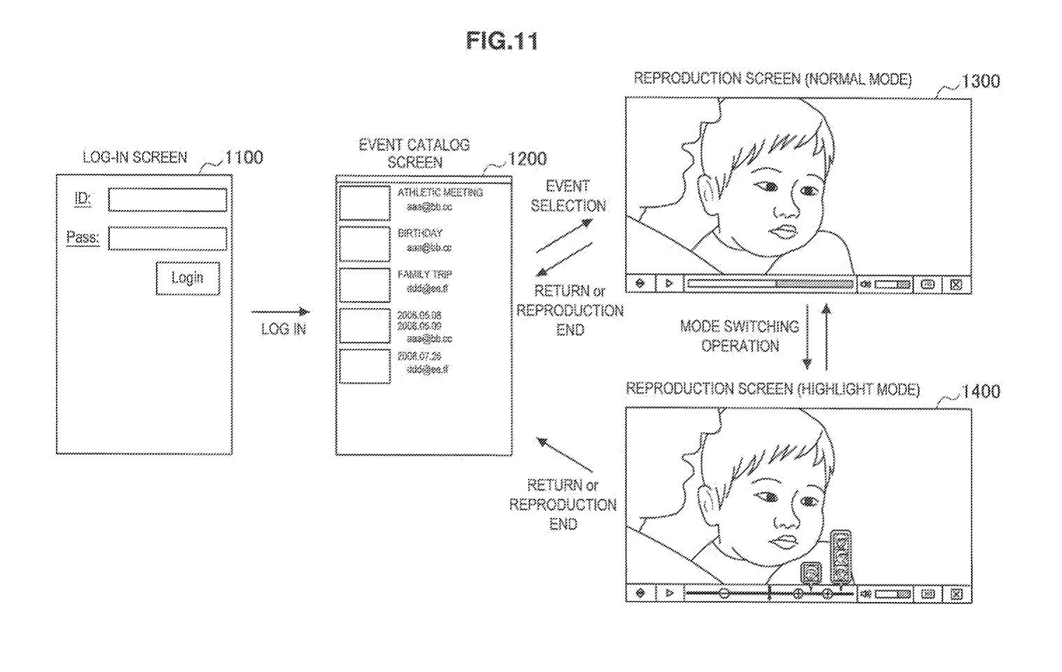

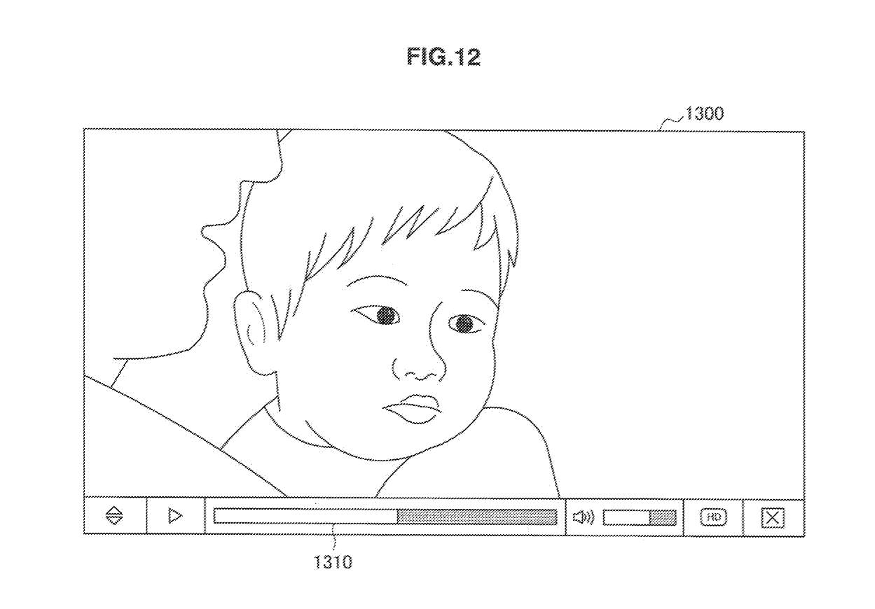

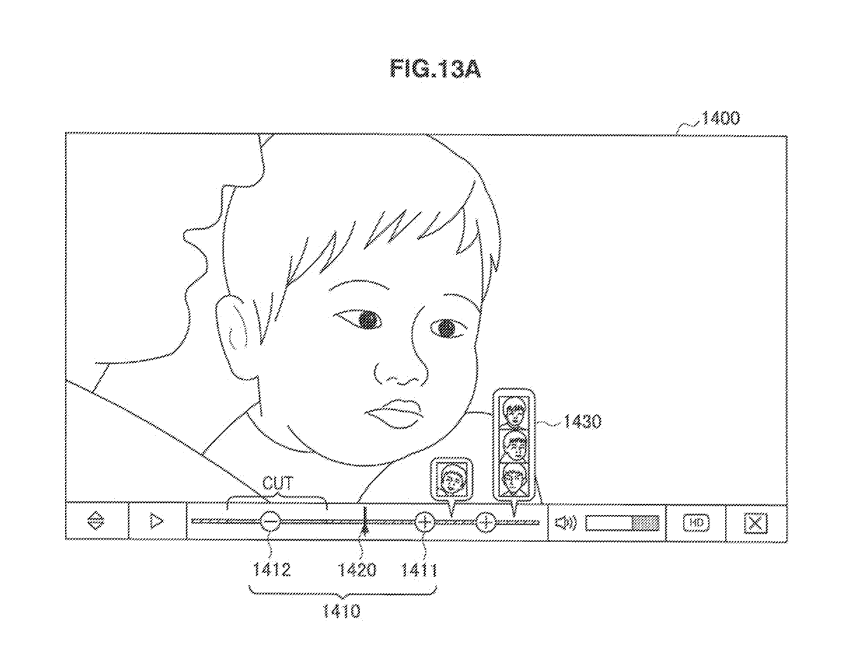

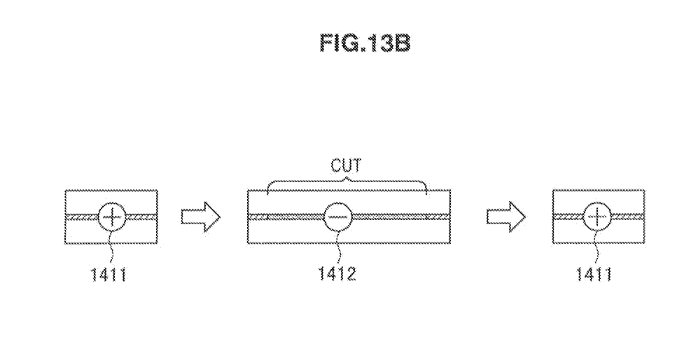

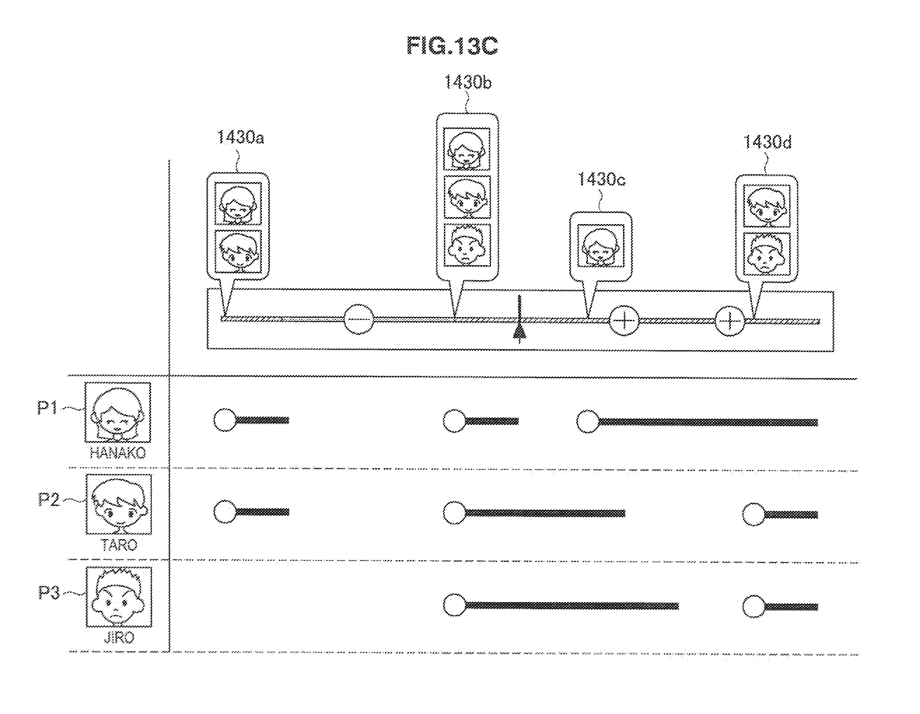

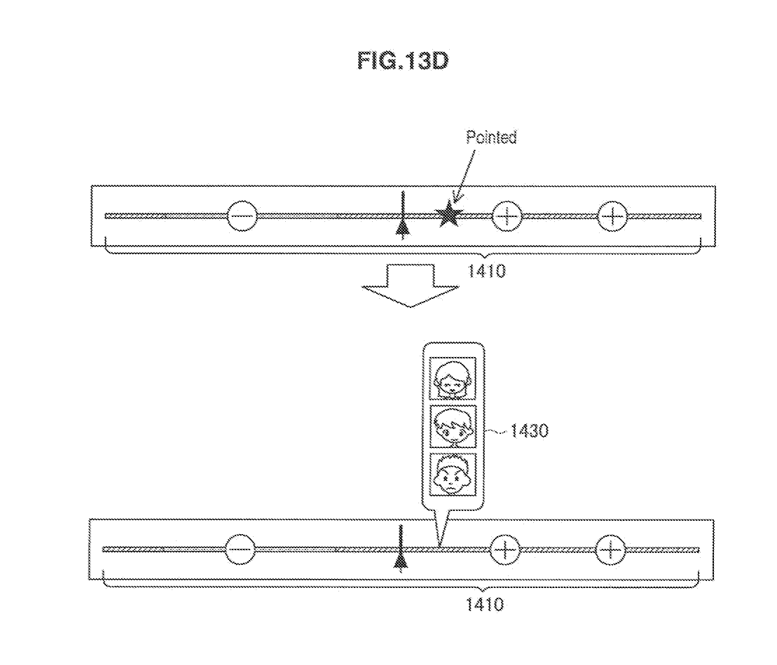

Next, with reference to FIGS. 11 to 13D, display during content view according to an embodiment of the present disclosure will be described. FIG. 11 is a diagram for describing a whole display during content view according to an embodiment of the present disclosure. FIG. 12 is a diagram showing an example of a normal mode reproduction screen according to an embodiment of the present disclosure. FIGS. 13A to 13D are diagrams showing an example of a highlight mode reproduction screen according to an embodiment of the present disclosure.

Referring to FIG. 11, in an embodiment of the present disclosure, for example, a log-in screen 1100, an event catalog screen 1200, a normal mode reproduction screen 1300, and a highlight mode reproduction screen 1400 are displayed during content view. These displays can be displayed on the display unit 330 by, for example, the content viewing client 300 and the display control unit 320.

When, for example, a user starts viewing shared content in the content viewing client 300, the display control unit 320 first causes the display unit 330 to display the log-in screen 1100. The log-in screen 1100 has input regions for ID and password, for example, as shown in the drawing. Using the log-in screen, the user logs into an account of a service which provides, for example, sharing of content. Thus, for example, the shared server 100 can identify which target user is using the content viewing client 300.

When the user successfully logs in, the event catalog screen 1200 is displayed. The event catalog screen 1200 is a screen displaying, for example, event information generated by the event information generation unit 150 of the shared server 100 as a list. The event catalog screen may display, for example, event representative images or flip thumbnails generated by the thumbnail image extraction unit 170 or thumbnail moving images acquired according to a thumbnail scenario generated by the scenario information generation unit 180 together with the event information. In this case, which of the event representative images flip thumbnails, or the thumbnail moving images is to be displayed may be decided based on, for example, portrayal performance of the content viewing client 300.

Herein, the event displayed on the event catalog screen 1200 may correspond to a specific event, for example, an “athletic meeting,” a “birthday,” a “family trip,” or the like as shown in the drawing, or may correspond simply to a range of photograph dates, such as “May 8, 2008 to May 9, 2008.” Since content is not necessarily limited to content photographed during a specific event, an event may be defined by a range of photograph dates, as in the example shown in the drawing.

In addition, on the event catalog screen 1200, information for identifying a user who provides content may be displayed together with an event name (or date). In the example shown in the drawing, as information for identifying a user who provides the content, e-mail addresses such as aaa@bb.cc are displayed, but the information is not limited thereto, and for example, a user ID, a nickname, and the like may be displayed.

When a user selects any event using the operation unit 340 on the event catalog screen 1200, reproduction of the content corresponding to the event is started. The content reproduced herein is, for example, a highlight moving image acquired in accordance with a highlight scenario generated by the scenario information generation unit 180 of the shared server 100.

In the example shown in the drawing, content is first reproduced on the normal mode reproduction screen 1300. Herein, when a user executes, for example, an operation of mode switching using the operation unit 340, the display is changed to the highlight mode reproduction screen 1400 while the reproduction of the content is continued. Herein, display of a progress bar by which the progress of content is displayed is different between the normal mode reproduction screen 1300 and the highlight mode reproduction screen 1400. The display of this progress bar will be described in the following portion in more detail.

When the user instructs, for example, reproduction end using the operation unit 340 on the normal mode reproduction screen 1300 or the highlight mode reproduction screen 1400, the reproduction of the content ends, and the display returns to the event catalog screen 1200.

### (Normal Mode Reproduction Screen)

FIG. 12 shows an example of the normal mode reproduction screen. On the normal mode reproduction screen 1300, a general progress bar 1310 is displayed. Note that, to the progress bar 1310, all techniques of the related art such as the technique disclosed in, for example, Japanese Unexamined Patent Application Publication No. 2008-67207 are applicable. In the example shown in the drawing, the progress bar 1310 displays the whole reproduced content. In the progress bar 1310, the portion that has already been reproduced and the portion that has not been reproduced yet are displayed in different colors. The border of the different colors corresponds to the portion that is being reproduced at present. A user can jump to an arbitrary location in the content by selecting an arbitrary location of the progress bar 1310 using the operation unit 340.

### (Highlight Mode Reproduction Screen)

FIG. 13A shows an example of the highlight mode reproduction screen. On the highlight mode reproduction screen 1400, a progress bar 1410 that is particularly appropriate for reproducing highlight content, for example, a highlight moving image, is displayed. Herein, the highlight content is content that includes a portion (a first section) that is reproduced and the other portion (a second section) that is not reproduced among sections included in original content.

When such highlight content is reproduced, for example, there is a case in which a user also desires to view cut portions. In such a case, for example, if a cut portion is not displayed on the progress bar, it is difficult for the user to recognize the cut portion (it is difficult to ascertain whether the portion that the user desires to view has been cut or is not included to begin with). However, if the progress bar is displayed including all cut portions, the progress bar comes to include many meaningless portions (portions that would not be reproduced unless the user desired to view them), and the display becomes inconvenient.

Thus, in this embodiment, by displaying the progress bar 1410 that is particularly appropriate for reproduction of highlight content, a user can view content more comfortably even in such a case.

The progress bar 1410 includes a + button 1411 and a − button 1412. In addition, on the highlight mode reproduction screen 1400, a reproducing location display 1420 and a person display 1430 are further displayed.

First, the progress bar 1410 is different from the progress bar 1310 displayed on the normal mode reproduction screen in that the former does not necessarily display the entire content to be displayed. The progress bar 1410 flows from the right to the left with the reproduction of content so that the portion that is being reproduced at present coincides with the reproducing location display 1420 (the location is fixed) (center focus). Thus, the + button 1411 and the − button 1412 disposed on the progress bar 1410 to be described later appear from the right end of the progress bar 1410, pass over the location of the reproducing position display 1420, flow to the left end of the progress bar 1410, and then disappear, unless the user particularly operates them in the state in which the content is reproduced.

### (+ Button and − Button)

Next, with reference also to FIG. 13B, the + button 1411 and the − button 1412 displayed on the progress bar 1410 will be further described.

The + button 1411 is a button indicating that there is a cut portion in reproduced content. As described above, the content reproduced in the example shown in the drawing is, for example, a highlight moving image acquired in accordance with a highlight scenario generated by the scenario information generation unit 180. The highlight moving image includes a portion that is not extracted as a scene in a moving image, for example, as shown in the example of FIG. 10B.

Herein, it is assumed that the user presses, for example, the + button 1411 using the operation unit 340. Then, the + button 1411 changes to the − button 1412, and a cut portion CUT of the content that was indicated by the + button 1411 is displayed. In FIGS. 13A and 13B, the portion on both sides of the − button 1412 displayed in a color different from that of the other portion is the cut portion CUT. The cut portion CUT indicates a portion that is not being reproduced (the second section) as a highlight moving image in the original content. For this reason, the cut portion CUT is displayed with an appearance different from that of the other portion of the progress bar 1410, for example, in a different color.

Thus, in the progress bar 1410, the portion other than the cut portion CUT may be expressed by a first bar indicating the first section of the content and the cut portion CUT may be expressed by a second bar that is displayed in a continuation of the first bar and indicates the second section. Then, the + button 1411 is also called an icon displayed on the first bar instead of the second bar indicating that the second section is not being reproduced.

The cut portion CUT displayed with the − button 1412 is not only displayed but also actually reproduced. When, for example, the + button 1411 located on the right side of the reproducing location display 1420 on the progress bar 1410 is pressed, a cut portion corresponding to this + button 1411 is displayed as the cut portion CUT, and when the cut portion CUT reaches the location of the reproducing location display 1420, the content is reproduced including the portion that had originally been cut.

The above operation is possible in such a way that, for example, data of the portion of the content that had been cut is newly acquired from the content server 400 so that the data is provided to the display control unit 320 according to an operation of pressing the + button 1411 acquired by the content acquisition unit 310 of the content viewing client 300 via the operation unit 340.

By the operation described above, the total length of the content to be reproduced extends. However, the whole of the progress bar 1410 does not originally correspond to the total length of the content, and is center-focused. For this reason, in the example of FIG. 13A, for example, even if the + button 1411 changes to the − button 1412 on the left side of the reproducing location display 1420, and the cut portion CUT is additionally displayed on both sides of the − button 1412, some of the portion on the left side of the cut portion CUT (portion that had not been cut) on the progress bar 1410 is merely not displayed, and a displaying location, for example, another + button 1411 displayed on the right side of the reproducing location display 1420, does not change.

On the other hand, when the user presses, for example, the − button 1412 using the operation unit 340, the − button 1412 changes to the + button 1411, and the cut portion CUT that has been displayed on both sides of the − button 1412 is no longer displayed. In this state, a cut portion is not reproduced so as to be, for example, the original highlight moving image. In addition, in this case, the total length of the content to be reproduced is shortened. However, as described above, since the whole of the progress bar 1410 does not originally correspond to the total length of the content, and is center-focused, the change of the − button 1412 to the + button 1411 does not affect the display of a region in, for example, the opposite side of the reproducing location display 1420 on the progress bar 1410.

Note that, in the example described above, since the highlight moving image is set to be reproduced in the initial setting, during the start of reproduction, content that does not include a cut portion is scheduled to be reproduced. At this moment, on the progress bar 1410, the cut portion CUT and the − button 1412 are not displayed, and the + button 1411 is displayed for the entire cut portion of the content.

### (Person Display)

Next, with reference also to FIG. 13C, an example of a person display 1430 displayed on the highlight mode reproduction screen 1400 will be further described. The person display 1430 indicates a location in content in which a target subject (person) who is associated with a target user (user viewing the content in the example shown in the drawing) appears in setting of content sharing.

In the example of FIG. 13C, the person display 1430 is displayed on locations on the content in which each of persons starts appearing. For example, a person display 1430a is displayed on a location at which persons P1 (Hanako) and P2 (Taro) appear for the first time. For this reason, the person display 1430a includes displays of the persons P1 (Hanako) and P2 (Taro). In addition, a person display 1430b is displayed on a location at which a person P3 (Jiro) appears for the first time and the persons P1 (Hanako) and P2 (Taro) disappear first and then start appearing again. For this reason, the person display 1430b includes displays of the persons P1 (Hanako), P2 (Taro), and P3 (Jiro).

On the other hand, a person display 1430c is displayed on a location at which the person P1 (Hanako) disappears first and then starts appearing again. At this point, since the persons P2 (Taro) and P3 (Jiro) continuously appear from the time point at which the previous person display 1430b was displayed, they are not included in the person display 1430c. Thus, the person display 1430c only includes a display of the person P1 (Hanako). In addition, a person display 1430d is displayed on a location at which the persons P2 (Taro) and P3 (Jiro) disappear first and then start appearing again. At this point, since the person P1 (Hanako) continuously appears from the time point at which the previous person display 1430c was displayed, she is not included in the person display 1430d. Thus, the person display 1430d only includes displays of the persons P2 (Taro) and P3 (Jiro).

With the person display 1430 as described above, for example, a user who views the content can recognize a timing at which each of the persons starts appearing. In this manner, it is possible to satisfy the need of a user in a case in which, for example, when the user views content and a person P disappears from the content, the user wants to find a location at which the person P emerges again, by displaying a timing of emergence, rather than a section of appearance.

As another example, the person display 1430 may be displayed in each scene or still image constituting a highlight moving image being reproduced. As described above, a highlight moving image is constituted by scenes or still images in which a target subject appears. Thus, in many cases, a target subject appearing changes in each scene or still image. For this reason, by displaying the person display 1430 in each scene or still image demarcated by the + button 1411, a user can be informed of which target user appears in displays of each scene or still image. In a case of a scene, for example, the person display 1430 may be displayed on the start location of the scene (the location of the + button 1411), or displayed in the middle of the scene (in the middle of the + buttons 1411 on front and rear sides).

Note that displaying or non-displaying of the person display 1430 can be switched by setting of, for example, the scenario player application (refer to FIG. 2). In addition, when a user selects the person display 1430 via the operation unit 340, for example, a reproducing section may jump to the location thereof.

Further, as another example of the person display 1430, when an arbitrary location on the progress bar 1410 is selected via the operation unit 340, or the like, as shown in FIG. 13D, the person display 1430 including a display of the persons P appearing in a portion corresponding to the location of the content may be displayed. This display may be possible even when, for example, the person display 1430 is set to be non-display by setting of a scenario player application.

### (6. Supplement)

### (Another Embodiment)

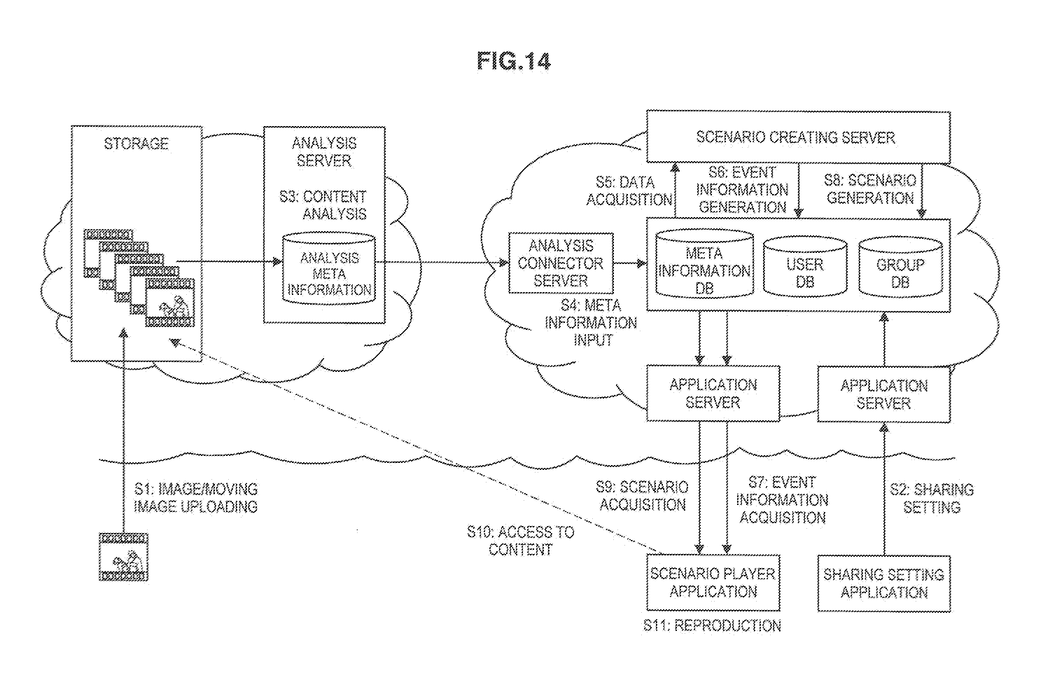

Note that the operation of the system described with reference to FIG. 2 above is also possible in, for example, another embodiment described with reference to FIG. 14 below. FIG. 14 is a diagram for describing an operation of a system according to another embodiment of the present disclosure. Note that, in this embodiment, since the functional configuration of the system is the same as that in the embodiment described above, detailed description thereof will not be repeated.

FIG. 14 shows the same operations as steps S1 to S11 described in FIG. 2. In this embodiment, however, each of the operations is executed in a distributed manner to a plurality of servers. In the example shown in the drawing, a process regarding an application on a client side is executed on an application server. In addition, an analysis server executing content analysis (S3) and a scenario creation server executing scenario creation (S8), and the like are separate servers. In this case, an analysis connector server may be provided for an input of meta information (S4) between the servers.

Note that all of the operations described with reference to FIGS. 2 and 14 above are merely examples of the embodiments of the present disclosure. In other words, both FIGS. 2 and 14 merely show an example of installation of, for example, the functional configuration of the present disclosure as shown in FIG. 1. As described above, the functional configuration of the present disclosure can be realized by an arbitrary system configuration including, for example, one or a plurality of server devices, and similarly, one or a plurality of client devices.

### (Hardware Configuration)

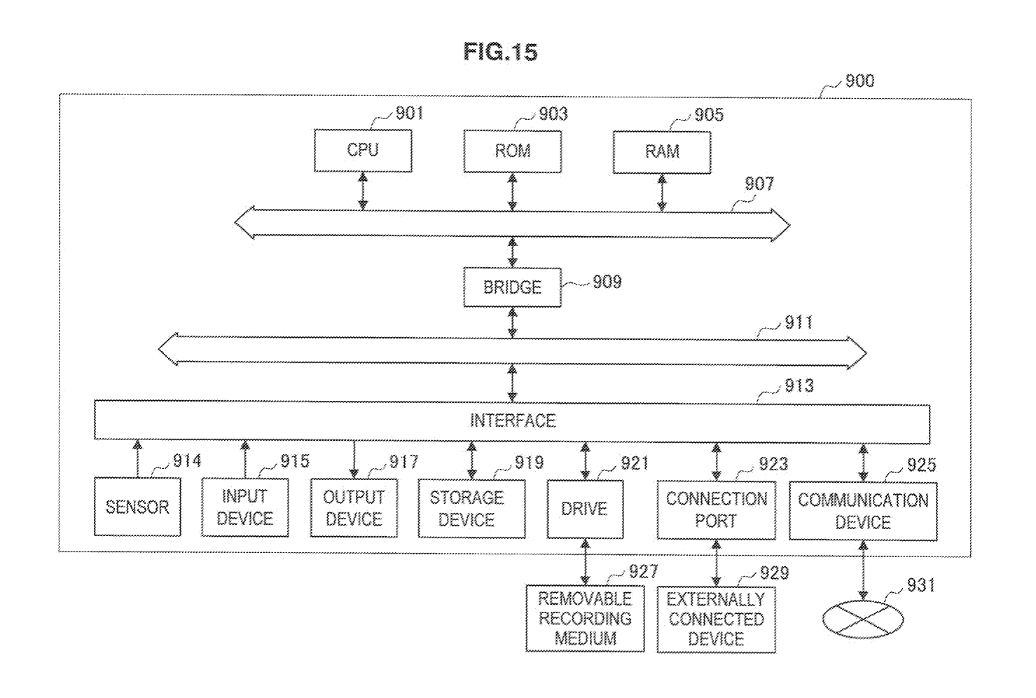

Next, with reference to FIG. 15, a hardware configuration of an information processing device 900 that can realize the shared server 100, the content providing client 200, the content viewing client 300, the content server 400, and the like according to an embodiment of the present disclosure will be described. FIG. 15 is a block diagram for describing a hardware configuration of the information processing device.

The information processing device 900 includes a CPU (Central Processing Unit) 901, a ROM (Read Only Memory) 903, and a RAM (Random Access Memory) 905. Further, the information processing device 900 may include a host bus 907, a bridge 909, an external bus 911, an interface 913, an input device 915, an output device 917, a storage device 919, a drive 921, a connection port 923, and a communication device 925. The information processing device 900 may have a processing circuit such as a DSP (Digital Signal Processor) instead of the CPU 901 or together therewith.

The CPU 901 functions as an arithmetic processing device and a control device, and controls all or a part of operations within the information processing device 900 in accordance with various programs recorded on the ROM 903, the RAM 905, the storage device 919, or a removable recording medium 927. The ROM 903 stores programs, arithmetic operation parameters, and the like, that the CPU 901 uses. The RAM 905 primarily stores programs used in the execution of the CPU 901, parameters that are appropriately changed in the execution, and the like. The CPU 901, the ROM 903, and the RAM 905 are connected to one another via the host bus 907 configured using an internal bus of a CPU bus, or the like. The host bus 907 is connected to an external bus 911 such as a PCI (Peripheral Component Interconnect/Interface) bus, or the like, via the bridge 909.

The input device 915 is a device, for example, a mouse, a keyboard, a touch panel, a button, a switch, a lever, or the like, which is operated by a user. The input device 915 may be a remotely controlled device using, for example, infrared rays, or another kind of radio waves, or may be an externally connected device 929 such as a mobile telephone that follows an operation of the information processing device 900. The input device 915 includes an input control circuit that generates an input signal based on information input by a user and outputs the signal to the CPU 901. The user inputs various kinds of data or instructs processing operations to the information processing device 900 by operating the input device 915.

The output device 917 is configured to be a device that can visually or acoustically notify a user of acquired information. The output device 917 can be, for example, a display device including an LCD (Liquid Crystal Display), a PDP (Plasma Display Panel), an organic EL (Electro-Luminescence) display, or the like, a voice output device including a speaker, a headphone, or the like, a printer device, or the like. The output device 917 can output a result obtained from a process of the information processing device 900 as text or a video such as an image, or as a voice or a voice including sound, or the like.

The storage device 919 is a device for storing data configured to be an example of a storage unit of the information processing device 900. The storage device 919 is configured to be, for example, a magnetic storage device such as an HDD (Hard Disk Drive), a semiconductor storage device, an optical storage device, or a magneto-optical storage device, or the like. This storage device 919 stores programs that the CPU 901 executes, various kinds of data, and various kinds of data acquired externally.

The drive 921 is a reader/writer for the removable recording medium 927 such as a magnetic disk, an optical disc, a magneto-optical disc, a semiconductor memory, or the like, and built in or externally attached to the information processing device 900. The drive 921 reads information recorded on the mounted removable recording medium 927 and outputs the information to the RAM 905. In addition, the drive 921 performs writing on the mounted removable recording medium 927.

The connection port 923 is a port for directly connecting a device to the information processing device 900. The connection port 923 can be, for example, a USB (Universal Serial Bus) port, an IEEE 1394 port, an SCSI (Small Computer System Interface) port, or the like. In addition, the connection port 923 may be an RS-232C port, an optical audio terminal, an HDMI (High-Definition Multimedia Interface) port, or the like. Various kinds of data can be exchanged between the information processing device 900 and the externally connected device 929 by connecting the externally connected device 929 to the connection port 923.

The communication device 925 is a communication interface configured to be, for example, a communication device for being connected to a communication network 931. The communication device 925 can be, for example, a wired or wireless LAN (Local Area Network), Bluetooth (registered trademark), or a communication card for WUSB (Wireless USB), or the like. In addition, the communication device 925 may be a router for optical communication, a router for ADSL (Asymmetric Digital Subscriber Line), or a modem for various kinds of communication. The communication device 925 transmits or receives signals or the like using a predetermined protocol such as TCP/IP, or the like, between, for example, the Internet or other communication devices. In addition, the communication network 931 connected to the communication device 925 is a network connected in a wired or a wireless manner, and is, for example, the Internet, a LAN for home use, infrared communication, radio wave communication, satellite communication, or the like.

An imaging device 933 is a device that images an actual space using various members, for example, an imaging element such as a CCD (Charge Coupled Device), or a CMOS (Complementary Metal Oxide Semiconductor), a lens for controlling image formation of a subject onto the imaging element, and the like, so as to generate a captured image. The imaging device 933 may be a device that images still images or moving images.

A sensor 935 includes various kinds of sensors, for example, an acceleration sensor, a gyro sensor, a geo-magnetic sensor, an optical sensor, a sound sensor, and the like. The sensor 935 acquires information, for example, regarding a state of the information processing device 900 itself such as the posture of the housing of the information processing device 900, and information regarding a peripheral environment of the information processing device 900 such as brightness, noise, or the like in the periphery of the information processing device 900. In addition, the sensor 935 may include a GPS (Global Positioning System) sensor that measures latitude, longitude, and altitude of a device by receiving GPS signals.

Hereinabove, an example of a hardware configuration of the information processing device 900 has been shown. Each constituent element described above may be configured using general-purpose members, or by hardware specialized in the function of each constituent element. The configuration can be appropriately modified according to technical levels in every execution.

### (Summary of Embodiment)

In the embodiments of the present disclosure, a subject that can be a target of interest of, for example, a sharing partner, is set for each sharing partner of content. According to this setting, a shared server automatically generates a scenario for constituting digest content. The digest content is content obtained by combining, for example, scenes or images that are meaningful for a sharing partner, and exemplified as a highlight moving image in the above embodiments. The shared server can execute automatic generation of a scenario, or the like, for content added after the above-described setting is made. Thus, a user who provides content may only add content to sharing targets after sharing setting is made once, with no particular additional operation.

In addition, as digest content, a thumbnail moving image may be generated. A thumbnail moving image is content obtained by further summarizing scenes or images meaningful for a sharing partner. While a highlight moving image is provided mainly for viewing of a sharing partner, a thumbnail moving image is presented to a sharing partner with, for example, information indicating an event for which content is to be photographed as a so-called thumbnail of a highlight moving image, thereby making selection of a viewing target easy.

As information for making the selection of a viewing target easy, a thumbnail image may also be displayed. A thumbnail image has been exemplified as a content representative image and a flip thumbnail in the above-described embodiments. Since a thumbnail image is an animation composed of a single image (still image) or a plurality of still images, it can be displayed even when, for example, the image processing capability of a client device is low.

In the above-described embodiments, a shared server provides a client with scenario information, and digest content such as a highlight moving image is generated in accordance with the scenario on the client side. However, when the image processing capability of a client device is low, or a communication state is stable, the shared server or a content server may generate digest content in accordance with the scenario and provide the client with the content.

In addition, an operation for setting a sharing partner, or a subject in association with a sharing partner, can be acquired using a GUI, for example, as shown in the above-described embodiments. The association of a sharing partner with a subject may be executed in such a way that, for example, the sharing partner and the subject are displayed as icons and a drag operation for associating each of the icons is performed. Accordingly, a user can perform sharing setting using an instantaneous operation.

In addition, when content obtained by extracting a portion of original content (by cutting another portion) such as a highlight moving image, or the like, is viewed, for example, there is a case in which it is also desired to view a portion cut before and after the extracted content after a user views the portion provided as the highlight moving image. In such a case, if a GUI that can instantaneously display the extracted portion and the cut portion using a + button, a − button, or the like, and make a change so as to reproduce the cut portion by operating such buttons, users can comfortably experience viewing content.

Note that, in the above description, the embodiments of the present disclosure relating mainly to an information processing device have been introduced, but, for example, an execution method in such an information processing device, a program for realizing the functions in the information processing device, and a recording medium on which such a program is recorded can also be realized as an embodiment of the present disclosure.

It should be understood by those skilled in the art that various modifications, combinations, sub-combinations and alterations may occur depending on design requirements and other factors insofar as they are within the scope of the appended claims or the equivalents thereof.

(1) A display control device including:

a display control unit that causes a reproduction image of content that includes a first section and a second section and a reproduction state display that indicates a reproduction state of the content to be displayed on a display unit,

wherein the reproduction state display includes a first bar that indicates the first section, a second bar that is displayed in a continuation of the first bar and indicates the second section, or a first icon that is displayed on the first bar instead of the second bar so as to indicate that the second section is not reproduced.

(2) The display control device according to (1), wherein the display control unit causes the second bar to be displayed instead of the first icon when the first icon is selected.
(3) The display control device according to (2), wherein the display control unit causes a second icon that is different from the first icon to be displayed on the second bar.
(4) The display control device according to (3), wherein the display control unit causes the first icon to be displayed instead of the second bar when the second icon is selected.
(5) The display control device according to any one of (2) to (4), further including:

a content acquisition unit that newly acquires data for reproducing the second section and provides the data to the display control unit when the first icon is selected.

(6) The display control device according to (5),

wherein, when reproduction of the content is started, the content acquisition unit acquires data for reproducing the first section and provides the data to the display control unit, and

wherein, when reproduction of the content is started, the display control unit causes the first bar and the first icon to be displayed.

(7) The display control device according to any one of (1) to (6), wherein the first bar and the second bar do not display the entire content.
(8) The display control device according to any one of (1) to (7), wherein the display control unit causes the second bar to be displayed with a different appearance from the first bar.
(9) The display control device according to (8), wherein the display control unit causes the second bar to be displayed in a different color from the first bar.
(10) The display control device according to any one of (1) to (9), wherein the reproduction state display is further displayed at least at a first location on the first bar, and includes a subject display that displays a subject appearing in the content at a portion corresponding to the first location.
(11) The display control device according to (10), wherein the first location corresponds to a portion at which the subject starts appearing.
(12) The display control device according to (10), wherein the first location corresponds to a start location of the first section.
(13) The display control device according to (10), wherein the first location is decided according to a user's operation.
(14) A display control method including:

displaying a reproduction image of content including a first section and a second section and a reproduction state display that indicates a reproduction state of the content on a display unit,

wherein the reproduction state display includes a first bar that indicates the first section, a second bar that is displayed in a continuation of the first bar and indicates the second section, or a first icon that is displayed on the first bar instead of the second bar so as to indicate that the second section is not reproduced.

(15) An information processing device including:

a sharing-related information acquisition unit that acquires information of a target user who is a sharing partner of content including a still image or a moving image and of a target subject that is a subject associated with the target user;

a content extraction unit that extracts content in which the target subject appears from the content as target content; and

a scenario generation unit that generates a scenario for composing digest content by combining the target content.

(16) The information processing device according to (15), further including:

a scene extraction unit that extracts portions in which the target subject appears from a moving image included in the target content as target scenes,

wherein the scenario generation unit generates a scenario for composing digest content by combining the target scenes.

(17) The information processing device according to (16), wherein the scenario generation unit generates a scenario for composing digest content by combining the target scenes and a still image included in the target content.
(18) The information processing device according to claim (16) or (17),

wherein the scene extraction unit selects representative scenes of the corresponding moving image from the target scenes, and

wherein the scenario generation unit generates a scenario for composing digest content by combining the representative scenes.

(19) The information processing device according to (18),

wherein the target subject is a person, and

wherein the scene extraction unit selects the representative scenes based on the degree of smile of the person.

(20) The information processing device according to any one of (15) to (19), further comprising:

a frame extraction unit that extracts frames in which the target subject appears from a moving image included in the target content as target frames and selects representative frames of the corresponding moving image from the target frames; and

an animation generation unit that generates a digest animation of the target content by combining the representative frames.

(21) The information processing device according to (20), wherein the animation generation unit generates the digest animation by combining the representative frames and a still image included in the target content.
(22) The information processing device according to any one of (15) to (19), further comprising:

a frame extraction unit that extracts frames in which the target subject appears from a moving image included in the target content as target frames and selects representative frames of the moving image from the target frames; and

a representative image selection unit that selects a representative image of the target content from the representative frames.

(23) The information processing device according to claim (22), wherein the representative image selection unit selects the representative image from the representative frame and a still image included in the target content.
(24) The information processing device according to any one of (15) to (23), further comprising:

a content classification unit that classifies the content for each event of a photographing target,

wherein the scenario generation unit generates the scenario for each of the event.

(25) The information processing device according to (24), further comprising:

an event information generation unit that generates event information including information of the event from which the scenario is generated.

(26) The information processing device according to (24) or (25), wherein the sharing-related information acquisition unit further acquires information of the event of which disclosure to the target user is permitted.
(27) The information processing device according to any one of (15) to (26), wherein the sharing-related information acquisition unit acquires information of a group of the target users and of the target subject associated with each group.
(28) The information processing device according to any one of (15) to (27), wherein the scenario generation unit generates the scenario for the content which is set as a target to be shared before information of the target user and the target subject is acquired and for the content which is added as a target to be shared after information of the target user and the target subject is acquired.
(29) The information processing device according to any one of (15) to (28), wherein the scenario generation unit outputs the scenario to an external device through which the target user views the digest content.
(30) A system comprising:

a first client device that includes an operation unit by which a first user who provides content including a still image or a moving image acquires an operation of setting a second user who is a sharing partner of the content and a target subject that is a subject associated with the second user;

a server device that includes a sharing-related information acquisition unit that acquires information of the second user and the target subject, a content extraction unit that extracts content in which the target subject appears from the content as target content, and a scenario generation unit that generates and outputs a scenario for composing digest content by combining the target content; and

a second client device that includes a content acquisition unit that acquires the output scenario and generates the digest content from the content in accordance with the scenario so as to provide the second user.

(31) The system according to (30),

wherein the first client device further includes a display control unit that causes icons indicating candidate subjects that are candidates for the target subject to be displayed on a display unit, and

wherein the operation unit acquires an operation of the first user to set the target subject by selecting an icon corresponding to a desired subject from the icons.

(32) An information processing method comprising:

acquiring information of a target user who is a sharing partner of content including a still image or a moving image and of a target subject that is a subject associated with the target user;

extracting content in which the target subject appears from the content as target content; and

generating a scenario for composing digest content by combining the target content.

The present disclosure contains subject matter related to that disclosed in Japanese Priority Patent Application JP 2012-033871 filed in the Japan Patent Office on Feb. 20, 2012 and JP 2012-033872 filed in the Japan Patent Office on Feb. 20, 2012, the entire content of which is hereby incorporated by reference.

What is claimed is:

1. A display control device comprising:
a display control unit that causes a reproduction image of content that includes a first section and a second section and a reproduction state display that indicates a reproduction state of the content to be displayed on a display unit,
wherein the reproduction state display includes a first bar that indicates the first section, a second bar that is displayed in a continuation of the first bar and indicates the second section, or a first icon that is displayed on the first bar instead of the second bar so as to indicate that the second section is not reproduced.

2. The display control device according to claim 1, wherein the display control unit causes the second bar to be displayed instead of the first icon when the first icon is selected.

3. The display control device according to claim 2, wherein the display control unit causes a second icon that is different from the first icon to be displayed on the second bar.

4. The display control device according to claim 3, wherein the display control unit causes the first icon to be displayed instead of the second bar when the second icon is selected.

5. The display control device according to claim 2, further comprising:
a content acquisition unit that newly acquires data for reproducing the second section and provides the data to the display control unit when the first icon is selected.

6. The display control device according to claim 5,
wherein, when reproduction of the content is started, the content acquisition unit acquires data for reproducing the first section and provides the data to the display control unit, and
wherein, when reproduction of the content is started, the display control unit causes the first bar and the first icon to be displayed.

7. The display control device according to claim 1, wherein the first bar and the second bar do not display the entire content.

8. The display control device according to claim 1, wherein the display control unit causes the second bar to be displayed with a different appearance from the first bar.

9. The display control device according to claim 8, wherein the display control unit causes the second bar to be displayed in a different color from the first bar.

10. The display control device according to claim 1, wherein the reproduction state display is further displayed at least at a first location on the first bar, and includes a subject display that displays a subject appearing in the content at a portion corresponding to the first location.

11. The display control device according to claim 10, wherein the first location corresponds to a portion at which the subject starts appearing.

12. The display control device according to claim 10, wherein the first location corresponds to a start location of the first section.

13. The display control device according to claim 10, wherein the first location is decided according to a user's operation.

14. A display control method comprising:
displaying a reproduction image of content including a first section and a second section and a reproduction state display that indicates a reproduction state of the content on a display unit,
wherein the reproduction state display includes a first bar that indicates the first section, a second bar that is displayed in a continuation of the first bar and indicates the second section, or a first icon that is displayed on the first bar instead of the second bar so as to indicate that the second section is not reproduced.
